(19) United States
(12) Patent Application Publication
(10) Pub. No.: US 2024/0257048 A1
(43) Pub. Date: Aug. 1, 2024

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Iwao NITTA, Nagoya-shi (JP); Teruyoshi Fujiwara, Toyota-shi (JP); Ryota Suzuki, Ikeda-shi (JP)

(73) Assignee: TOYOTA JIDOSHA KABUSHIKI KAISHA, Toyota-shi (JP)

(21) Appl. No.: 18/399,056

(22) Filed: Dec. 28, 2023

(30) Foreign Application Priority Data
Jan. 31, 2023 (JP) 2023-013247

(51) Int. Cl. G06Q 10/087; B65G 1/137

(52) U.S. Cl. CPC G06Q 10/087; B65G 1/1373

(57) ABSTRACT

An information processing device includes one or more processors. The one or more processors are configured to receive identification information of a first product and information on a second platform from a terminal of a first company, transmit a disclosure request for information on the first product to the second platform, receive the information on the first product and information on a second company from the second platform in response to the disclosure request, and register the information on the first product on a first platform in association with the first company. The one or more processors are configured to perform, for the second company, at least one of: generating a temporary account on the first platform; and registering the information on the second company on the first platform in association with the first company.

### CROSS-REFERENCE TO RELATED APPLICATION

This application claims priority to Japanese Patent Application No. 2023-013247 filed on Jan. 31, 2023, incorporated herein by reference in its entirety.

### BACKGROUND

### 1. Technical Field

The present disclosure relates to an information processing device and an information processing method.

### 2. Description of Related Art

A system in which information on transaction products is shared between a vendor company and a customer company is proposed (e.g., Japanese Unexamined Patent Application Publication No. 2004-171146 (JP 2004-171146 A)). With this system, the information can be shared by a common platform between adjacent companies in a supply chain.

### SUMMARY

The present disclosure provides a technology that reduces time and effort required to input product information.

An information processing device according to a first aspect of the present disclosure includes one or more processors. The one or more processors are configured to execute receiving identification information of a first product and information on a second platform from a terminal of a first company. The first company has not registered information on the first product on a first platform and has already registered the information on the first product on the second platform different from the first platform. The one or more processors are configured to execute transmitting a disclosure request for the information on the first product to the second platform. The disclosure request includes the identification information of the first product. The one or more processors are configured to execute receiving the information on the first product and information on a second company from the second platform in response to the disclosure request. The second company is a company of a second product positioned upstream of the first product. The one or more processors are configured to execute registering the information on the first product on the first platform in association with the first company. The one or more processors are configured to perform, for the second company, at least one of: generating a temporary account on the first platform; and registering the information on the second company on the first platform in association with the first company.

In the information processing device according to the first aspect of the present disclosure, the information on the first product may include traceability-related information of the first product.

In the information processing device according to the first aspect of the present disclosure, the traceability-related information may include information on an amount of greenhouse gas emission.

In the information processing device according to the first aspect of the present disclosure, the one or more processors may be configured to execute acquiring information on location of the first platform and information on location of the second platform, and converting the information on the amount of greenhouse gas emission based on a relationship between the location of the first platform and the location of the second platform. The registering the information on the first product may include registering the converted information on the amount of greenhouse gas emission in association with the first company.

In the information processing device according to the first aspect of the present disclosure, the one or more processors may be configured to execute at least one of the transmitting and the receiving via a predetermined connector.

In the information processing device according to the first aspect of the present disclosure, the information on the second company may include information on the second product. The registering the information on the second company may include registering the information on the second product in association with the first company as a proxy applicant of the information on the second product.

In the information processing device according to the first aspect of the present disclosure, the information on the first product that is received from the second platform by the one or more processors may include information indicating designation of a disclosure range by the terminal of the first company.

In the information processing device according to the first aspect of the present disclosure, the one or more processors may be configured to, when the one or more processors have executed the generating the temporary account on the first platform, assign the temporary account generated on the first platform to the second company as a regular account in response to a message that is received from the terminal of the first company or a terminal of the second company and that indicates that the second company has accepted to participate in the first platform.

In the information processing device according to the first aspect of the present disclosure, the information on the second company may include information on the second product. A storage area that stores the information on the second product may be associated with the first company until the regular account is assigned to the second company. Association of the storage area may be transferred from the first company to the second company after the regular account is assigned to the second company.

In the information processing device according to the first aspect of the present disclosure, the first product and the second product may be products related to a battery.

An information processing method according to a second aspect of the present disclosure includes executing, by a computer: receiving identification information of a first product and information on a second platform from a terminal of a first company, the first company having not registered information on the first product on a first platform and having already registered the information on the first product on the second platform different from the first platform: transmitting a disclosure request for the information on the first product to the second platform, the disclosure request including the identification information of the first product: receiving the information on the first product and information on a second company from the second platform in response to the disclosure request, the second company being a company of a second product positioned upstream of the first product: registering the information on the first product on the first platform in association with the first company; and performing, for the second company, at least one of: generating a temporary account on the first platform; and registering the information on the second company on the first platform in association with the first company.

In the information processing method according to the second aspect of the present disclosure, the information on the first product may include traceability-related information of the first product.

In the information processing method according to the second aspect of the present disclosure, the traceability-related information may include information on an amount of greenhouse gas emission.

The information processing method according to the second aspect of the present disclosure may further include executing, by the computer: acquiring information on location of the first platform and information on location of the second platform; and converting the information on the amount of greenhouse gas emission based on a relationship between the location of the first platform and the location of the second platform. The registering the information on the first product may include registering the converted information on the amount of greenhouse gas emission in association with the first company.

The information processing method according to the second aspect of the present disclosure may further include executing, by the computer, at least one of the transmitting and the receiving via a predetermined connector.

In the information processing method according to the second aspect of the present disclosure, the information on the second company may include information on the second product. The registering the information on the second company may include registering the information on the second product in association with the first company as a proxy applicant of the information on the second product.

In the information processing method according to the second aspect of the present disclosure, the information on the first product that is received from the second platform by the computer may include information indicating designation of a disclosure range by the terminal of the first company.

The information processing method according to the second aspect of the present disclosure may further include executing, by the computer, when the computer has executed the generating the temporary account on the first platform, assigning the temporary account generated on the first platform to the second company as a regular account in response to a message that is received from the terminal of the first company or a terminal of the second company and that indicates that the second company has accepted to participate in the first platform.

In the information processing method according to the second aspect of the present disclosure, the information on the second company may include information on the second product. A storage area that stores the information on the second product may be associated with the first company until the regular account is assigned to the second company. Association of the storage area may be transferred from the first company to the second company after the regular account is assigned to the second company.

In the information processing method according to the second aspect of the present disclosure, the first product and the second product may be products related to a battery.

Another aspect of the present disclosure relates to a program for causing a computer to execute a process in the information processing device described above, and a non-transitory storage medium storing the program.

According to the present disclosure, it is possible to reduce the time and effort required to input the product information.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 illustrates an example of a supply chain according to a first embodiment:

FIG. 2 illustrates an example of relationships among products supplied by the supply chain;

FIG. 3 shows an outline of a process to be performed between company terminals and a server device;

FIG. 4 is a hardware configuration diagram of the server device according to the first embodiment;

FIG. 5 is a hardware configuration diagram of the company terminal according to the first embodiment;

FIG. 6 is a software configuration diagram of the server device according to the first embodiment;

FIG. 7 is a software configuration diagram of the company terminal according to the first embodiment;

FIG. 8 shows an example of product information generated by a product information generating unit;

FIG. 9 shows an example of a screen output by an authority setting unit;

FIG. 10 shows an example of permission information generated by the authority setting unit based on input information;

FIG. 11 shows an example of a user interface including a list of products that are linking destination candidates;

FIG. 12 shows an example of a flow of a process to be executed by the server device;

FIG. 13 illustrates a product tree and an amount of carbon dioxide emitted in each process;

FIG. 14 shows an example of a screen in which the product tree is output as an image;

FIG. 15 shows an example of the product tree in a case where products without access authority are hidden;

FIG. 16 is a sequence diagram illustrating a process to be performed by the server device and the company terminal in first to third phases;

FIG. 17 is a sequence diagram illustrating a process to be performed by the server device and the company terminal in a fourth phase;

FIG. 18 illustrates an example of a relationship between products in two supply chains;

FIG. 19 shows an example of product information generated by an information collecting unit or a proxy input unit;

FIG. 20 shows a case where a storage area associated with a temporary account of a second company is generated in a storage unit;

FIG. 21 shows a case where a storage area is allocated so that information on a second product is managed by a first company;

FIG. 22 shows the storage unit when a storage area is allocated to the second company;

FIG. 23 is a sequence diagram showing an example of a flow of a process in which a first server device acquires first product information and second company information from a second server device; and

FIG. 24 is a flowchart showing a flow of a registration process for a first product to be performed by the first server device.

### DETAILED DESCRIPTION OF EMBODIMENTS

Carbon Footprint of Products (CFP) is a system for converting, into CO₂, the amount of greenhouse gas emitted throughout the life cycle of a product from procurement of raw materials to disposal or recycling, and displaying it on the product. In order to realize the CFP, it is important to secure traceability, that is, to record suppliers involved in the process from procurement of raw materials to disposal or recycling of a product, and keep the history traceable. In a case where a supplier delivers products to a plurality of companies, different platforms may be used for individual delivery destinations even though the target product is the same. In this case, the supplier is required to input the same information to each platform, thereby requiring time and effort to input the information. This problem is not limited to the situation where information on the carbon footprint is collected. This problem may occur in every situation where any information on a product is collected, such as other traceability-related information (e.g., a recycling rate of a raw material or due diligence information) or other information on the product (e.g., components or identification information).

In view of the above, an information processing device according to one aspect of the present disclosure includes a control unit. The control unit is configured to receive identification information of a first product and information on a second platform from a terminal of a first company. The first company has not registered information on the first product on a first platform. The first company has already registered the information on the first product on the second platform different from the first platform. The control unit is configured to transmit a disclosure request for the information on the first product to the second platform. The disclosure request includes the identification information of the first product. The control unit is configured to receive the information on the first product and information on one or more second companies of one or more second products from the second platform in response to the disclosure request. The second product is a product positioned upstream of the first product. The control unit is configured to register the information on the first product on the first platform in association with the first company. The control unit is configured to perform, for at least a part of the second companies, at least one of generation of a temporary account on the first platform and registration of the information on the second company on the first platform in association with the first company.

The first platform and the second platform are platforms for managing pieces of information on the products of the companies. The first platform and the second platform manage respective supply chains. Products of a plurality of companies belong to each supply chain. The first product of the first company is a product constituting the supply chain together with the products of other companies and already registered on the second platform. The first product of the first company is a product that will participate in the first platform. The second product of the second company is a product constituting the supply chain together with the products of other companies and already registered on the second platform.

The first product of the first company incorporates the second product of the second company. There may be a plurality of second products. The first product is a product closer to a root node than the second product. For example, the second product may be used in a manufacturing process of the first product. For example, the first product and the second product may be the same product. In this case, for example, the first company may be a company that transports the first product. The first product and the second product may be, for example, materials, single components, assembly components, or completed products. Since the information on the first product of the first company is not registered on the first platform, it is desirable to register the information on the first product in order to secure the traceability. Therefore, the control unit registers the first product on the first platform by using the information on the first product registered on the second platform.

The control unit receives the identification information of the first product and the information on the second platform from the terminal of the first company. The information on the first product has been input on the second platform. The control unit transmits the disclosure request for the information on the first product to the second platform. At this time, a disclosure request including the identification information of the first product is transmitted to the second platform. The second platform that has received the disclosure request transmits the information on the first product to the first platform. In this way, the control unit can acquire the information on the first product. Therefore, the information on the first product can be registered on the first platform.

The control unit registers the information on the first product on the first platform in association with the first company. In this way, the information on the first product can be registered based on the information received from the first company. Therefore, the traceability can be secured. The first company can reduce time and effort required to input the information on the first product to the first platform.

The control unit receives the information on one or more second companies of one or more second products positioned upstream of the first product. That is, the second product is necessary for manufacturing the first product, and is manufactured prior to the manufacturing stage of the first product. In order to secure the traceability, it is more appropriate to register not only the information on the first product but also the information on the second product positioned upstream of the first product on the first platform. Therefore, the control unit also receives the information on the second company. The control unit may generate a temporary account on the first platform for the second company. By generating the temporary account associated with the second company, the second company can easily participate in the platform. The control unit may register the information on the second company on the first platform in association with the first company. Thus, the information on the second company can be used on the first platform. When the information on the second company is prestored on the first platform, the second company can easily participate in the first platform.

The information processing device may be a server of the first platform. Alternatively, the information processing device may be a server that is independent of the first platform and provides information acquired from the second platform to the first platform.

The information on the first product may include traceability-related information of the first product. The traceability-related information is information necessary to secure the traceability. The traceability-related information is typically information for calculating an amount of greenhouse gas emission, a recycling rate of a raw material, or a score related to due diligence. That is, the control unit registers the traceability-related information of the first product on the first platform in association with the first company. Thus, the first company can save time and effort required to input the traceability-related information of the first product multiple times.

The traceability-related information may include information on the amount of greenhouse gas emission. That is, the control unit registers the information on the amount of greenhouse gas emission on the first platform in association with the first company. Thus, the first company can save time and effort required to input the amount of greenhouse gas emission for the first product multiple times. The information on the amount of greenhouse gas emission for the first product may be information on the total amount of greenhouse gas emitted until the first product is obtained. Alternatively, the information on the amount of greenhouse gas emission may be information on the amount of greenhouse gas emitted in the first company involved in the manufacturing activities of the first product.

The control unit may further be configured to acquire information on location of the first platform and information on location of the second platform, and convert (generate) the information on the amount of greenhouse gas emission based on a relationship between the location of the first platform and the location of the second platform. The registration of the information on the first product may include registration of the converted information on the amount of greenhouse gas emission in association with the first company. When the location of the first platform and the location of the second platform are different, the use ratio of renewable energy in the supplied energy may be different. Then, the amount of greenhouse gas emission may be different depending on the location even if the same product is manufactured. The accuracy of the CFP can be increased by converting the amount of greenhouse gas depending on the location. The traceability can be secured by registering the converted information on the amount of greenhouse gas emission in association with the first company. The location of the platform may be a region for which the traceability-related information is collected. For example, even if a platform of Japan is constituted by a server located outside Japan, the location of the platform is Japan and is not the location of the server.

The control unit can perform at least one of the transmission and the reception via a predetermined connector. Different connectors may be used on the first platform and the second platform. Information can be transmitted and received between the platforms via the predetermined connectors associated with the platforms.

The information on the second company includes information on the second product. The registration of the information on the second company can include registration of the information on the second product in association with the first company, with the first company serving as a proxy applicant of the information on the second product. When the second product is registered in association with the first company, the first company may be liable to manage the information on the second product. However, the first company has more liability for the management of the second product that is not an in-house product. By registering the second product with the first company serving as the proxy applicant, the first company may be free of the liability for the management of the information on the second product. For example, the first platform may hold inquiries for the second company, and automatically send the inquiries to the second company to manage the information. As another method, the first platform may register the first company as a manager so that the first company corrects the information on the second product or is requested to correct the information on the second product.

The information on the first product that is received from the second platform by the control unit may include information indicating designation of a disclosure range by the terminal of the first company. Since the first company can designate the disclosure range, it is possible, for example, not to disclose confidential information or information whose disclosure is restricted by laws. Therefore, the convenience of the first company can be improved.

When the control unit has generated the temporary account on the first platform, the control unit may assign the temporary account generated on the first platform to the second company as a regular account in response to a message that is received from the terminal of the first company or a terminal of the second company and that indicates that the second company has accepted to participate in the first platform. That is, when the second company participates in the first platform, the temporary account is assigned as the regular account to facilitate the participation of the second company in the first platform. There is no need to generate a new account on the first platform. The message indicating the acceptance to participate in the first platform may be transmitted directly from the terminal of the second company to the first platform or via the first company.

The information on the second company includes information on the second product. A storage area that stores the information on the second product may be associated with the first company until the regular account is assigned to the second company. Association of the storage area may be transferred from the first company to the second company after the regular account is assigned to the second company. By transferring the association of the storage area from the first company to the second company, the second company can save time and effort required to register the information on the second product on the first platform. Therefore, the second company can easily participate in the first platform. As another method, the information on the second product may be deleted from the storage area associated with the first company after the regular account is assigned, and newly stored in a storage area associated with the second company.

The first product and the second product may be products related to a battery. That is, the first product and the second product may be products to be used when manufacturing a battery. Thus, the traceability for the battery can be secured.

Hereinafter, embodiments of the present disclosure will be described with reference to the drawings. The configurations of the following embodiments are illustrative, and the present disclosure is not limited to the configurations of the embodiments. The following embodiments can be combined if possible.

### First Embodiment

A system according to the present embodiment provides information on products supplied by a supply chain including a plurality of companies. The information on products is typically information on traceability.

First, the structure of the supply chain will be described. In one example, at least some companies (intermediate suppliers) in the supply chain may receive components from one or more upstream companies, produce in-house products by using the received components, and deliver the produced in-house products to companies in the next step (downstream companies). Most upstream companies may directly produce in-house products and deliver the produced in-house products to companies in the next step. Some companies in the supply chain may directly deliver, to different companies, products received from other companies (i.e., participate in distribution). A plurality of companies repeats this process, and a final product is obtained in the final step.

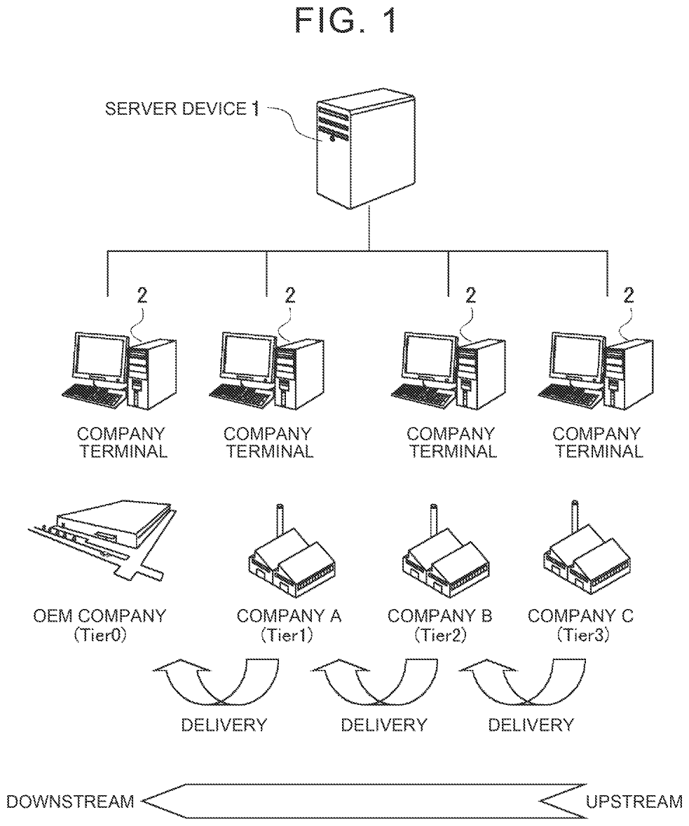

FIG. 1 illustrates an example of the supply chain according to the present embodiment. In the example of FIG. 1, it is assumed that a product related to an automobile is obtained. Specifically, the supply chain shown in FIG. 1 includes an original equipment manufacturing (OEM) company and a plurality of supplier companies. The OEM company is a company that assembles a final product, and the supplier companies (companies A to C) are companies that supplies components, materials, assemblies, etc. for manufacturing the final product. The supplier companies each produce a plurality of products and deliver the products to a company positioned one level lower. The companies repeat this process, and a final product is assembled in the final step.

In certain hierarchical levels in the present embodiment, the side that delivers a product will be referred to as “upstream side”, and the side that purchases the product and produces a new product will be referred to as “downstream side”. A company positioned on the upstream side will herein be referred to as “upstream company”, and a company positioned on the downstream side will herein be referred to as “downstream company”. A product produced by the upstream company will be referred to as “upstream product”, and a product produced by the downstream company will be referred to as “downstream product”. The downstream product (manufacture of the downstream product) incorporates the upstream product.

In the present embodiment, the hierarchical levels in the supply chain will be referred to as “tiers”. Tier 0 is the lowest level (corresponding to the OEM company) at which the final product is assembled, and transition is made to the upstream side in the order of Tiers 1, 2, and 3. The downstream company may turn into an upstream company depending on the level of interest. For example, the company B positioned in Tier 2 is a downstream company in relation to Tier 3, but is an upstream company in relation to Tier 1. Thus, the definitions of the upstream company and the downstream company may vary from level to level.

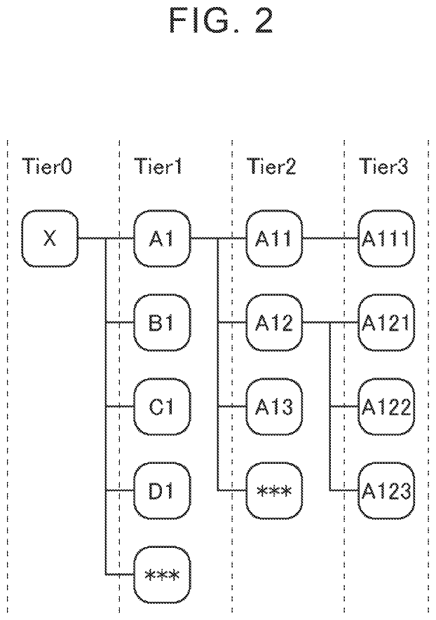

FIG. 2 illustrates an example of relationships among products supplied by the supply chain. Supply relationships among a plurality of products constituting a final product X are represented by a tree diagram. In this example, the final product X is produced by assembling products A1, B1, C1, D1, etc. The product A1 is produced by assembling products A11, A12, A13, etc. In this way, the relationships among the products constituting the final product can be represented by a tree diagram in which the individual products serve as nodes. A tree diagram for a specific final product will hereinafter be referred to as “product tree”. In one example, the final product X is a battery to be mounted on a battery electric vehicle (BEV). In another example, the final product X may be an automobile or an automobile-related product such as an automotive assembly.

A server device 1 according to the present embodiment collects pieces of information on products produced by the companies (hereinafter referred to as “product information”) and information for linking the pieces of product information from terminals associated with the companies (company terminals 2), and generates the product tree based on these pieces of information. The product information includes information on traceability (e.g., information on the amount of greenhouse gas emissions: hereinafter referred to as “traceability-related information”). A carbon footprint etc. can be traced by tracing the product tree. The traceability-related information may include any information that can be a target for securing traceability.

As shown in FIG. 1, an information processing system according to an example of the present embodiment includes the server device 1 and a plurality of company terminals 2. The company terminals 2 are associated with the companies constituting the supply chain. The system may include a plurality of company terminals 2. The server device 1 collects pieces of information for generating a product tree from the company terminals 2. The server device 1 generates the product tree based on the collected pieces of information. The server device 1 can execute a traceability-related process (typically a process for calculating the amount of carbon dioxide emission) based on the generated product tree. The result of execution of the process can be transmitted to the company terminals 2.

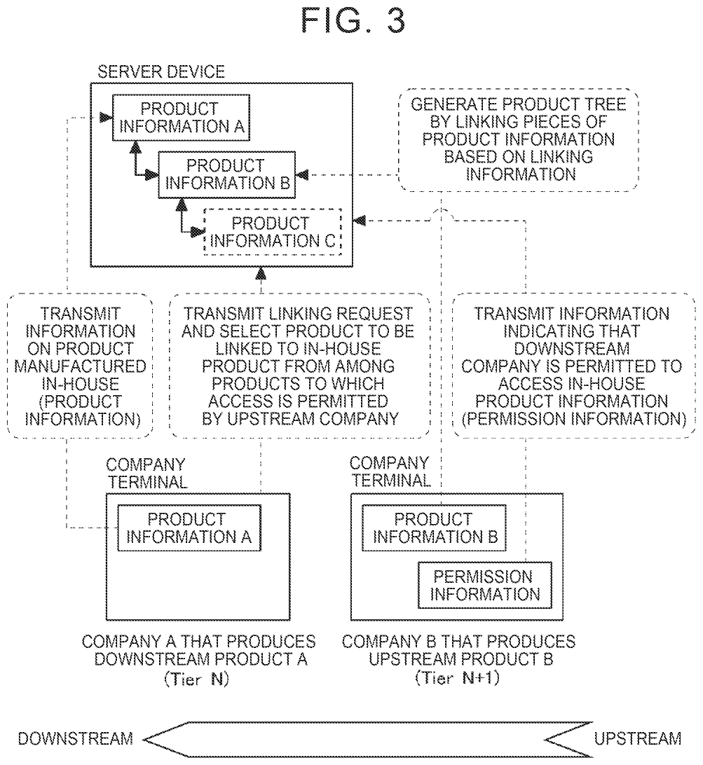

Next, an outline of a process for generating the product tree by the server device 1 will be described with reference to FIG. 3. FIG. 3 shows an outline of a process to be performed between the company terminals 2 and the server device 1. In the example of FIG. 3, it is assumed that a downstream company A and an upstream company B are present at any hierarchical levels. It is assumed that the company B produces a product B and delivers it to the company A, and the company A produces a product A by using the product B. That is, in the example of FIG. 3, the product B is a child node of the product A on the product tree.

To generate the product tree, the company terminals 2 associated with the companies A, B transmit pieces of information on products produced by the companies A, B to the server device 1. In this example, the company terminal 2 associated with the company A transmits product information on the product A (referred to as “product information A”) to the server device 1. Similarly, the company terminal 2 associated with the company B transmits product information on the product B (referred to as “product information B”) to the server device 1. The product information of each company is stored in the server device 1.

An operation for linking the pieces of product information stored in the server device 1 is performed by the company terminal 2. In one example, a representative person of a downstream company logs into the server device 1 from the company terminal 2 by using an account of the downstream company, and selects an upstream product to be linked with a downstream product that is the in-house product. In this way, the pieces of product information are linked from the downstream product to the upstream product. The server device 1 links the pieces of product information with each other based on the selection made by the representative person of the downstream company.

If all the products in the supply chain and all the pieces of information on the products are presented as options for the selection of the product to be linked, however, the confidentiality will be lost for information on the companies constituting the supply chain and information on the products produced by the companies. Further, it may be inappropriate to disclose the entire product tree to one supplier.

Therefore, the server device 1 according to the present embodiment invests authority to access the product information of the upstream product in the downstream company in advance in response to a request from the upstream company. The server device 1 permits reference from the downstream company within a range of the invested authority.

In the example of FIG. 3, the company terminal 2 associated with the upstream company B transmits, to the server device 1, an instruction request (information) to “invest the company A with authority to access the product information B”. When a linking request is received from the company terminal 2 associated with the company A, the server device 1 provides only a list of product information that the company A is authorized to access, and prompts the company A to make selection for product information to be linked. When the company terminal 2 associated with the company A requests reference to the product tree, the server device 1 provides the company terminal 2 with the product tree in which information other than the information that the company A is authorized to access is concealed. Thus, the information on irrelevant companies and products can be concealed.

### Hardware Configurations

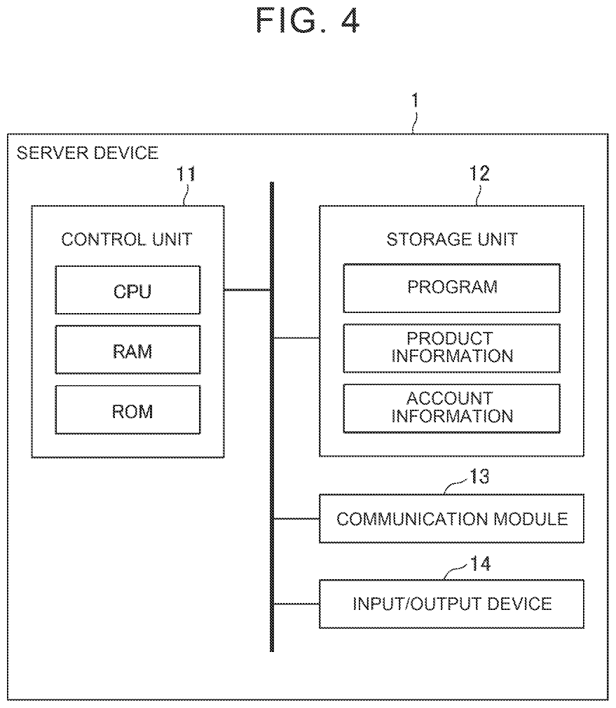

Next, the hardware configuration of the device constituting the system will be described with reference to FIG. 4. FIG. 4 schematically shows an example of the hardware configuration of the server device 1 according to the present embodiment. The server device 1 is a computer including a control unit 11, a storage unit 12, a communication module 13, and an input/output device 14.

The server device 1 may be a computer including a processor (e.g., a central processing unit (CPU) or a graphics processing unit (GPU)), a main storage device (e.g., a random access memory (RAM) or a read only memory (ROM)), and an auxiliary storage device (e.g., an erasable programmable read only memory (EPROM), a hard disk drive, or a removable medium). An operating system (OS), various programs, various tables, etc. are stored in the auxiliary storage device. The programs stored in the auxiliary storage device are executed such that various functions (software modules) can be implemented to meet a predetermined purpose as described later. Some or all of the modules may be implemented as hardware modules by a hardware circuit such as an application specific integrated circuit (ASIC) or a field programmable gate array (FPGA).

The control unit 11 is an arithmetic unit that implements various functions of the server device 1 by executing a predetermined program. The control unit 11 can be implemented by, for example, a hardware processor such as a CPU. The control unit 11 may include a RAM, a read only memory (ROM), a cache memory, etc.

The storage unit 12 is means for storing information, and is constituted by a storage medium such as a RAM, a magnetic disk, or a flash memory. The storage unit 12 stores programs to be executed by the control unit 11, data to be used by the programs, etc. A database is constructed in the storage unit 12. The database stores pieces of product information collected from the company terminals 2 and pieces of account information related to the companies. Details will be described later.

The communication module 13 is a communication interface for connecting the server device 1 to a network. The communication module 13 may include, for example, a network interface board and a wireless communication interface for wireless communication. The server device 1 can perform data communication with other computers (e.g., another server device 1 or the company terminals 2) via the communication module 13.

The input/output device 14 is means for receiving an input operation performed by an operator and presenting information to the operator. Specifically, the input/output device 14 includes input devices such as a mouse and a keyboard, and output devices such as a display and a speaker. The input/output device may be an integrated device such as a touch panel display.

In the specific hardware configuration of the server device 1, any component may be omitted, replaced, or added as appropriate depending on embodiments. For example, the control unit 11 may include a plurality of hardware processors. The hardware processor may be a microprocessor, an FPGA, a GPU, etc. The input/output device 14 may be omitted, or an input/output device other than the illustrated one (e.g., an optical drive) may be added. The server device 1 may be constituted by a plurality of computers. In this case, the hardware configurations of the computers may or may not agree with each other.

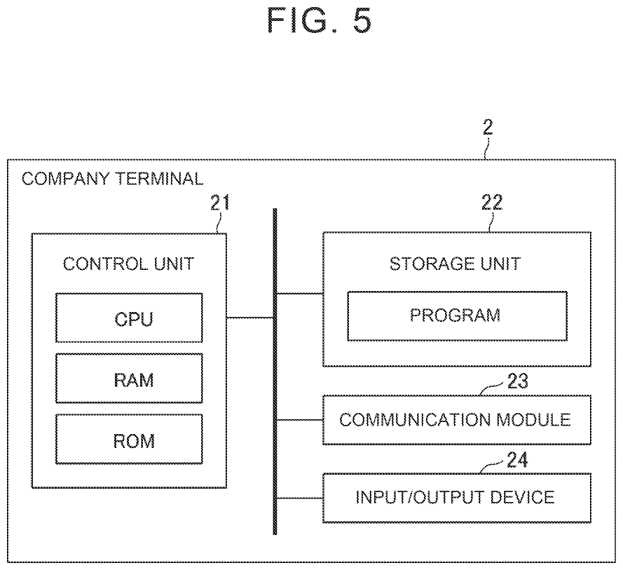

FIG. 5 schematically shows an example of the hardware configuration of the company terminal 2 according to the present embodiment. The company terminal 2 is a computer including a control unit 21, a storage unit 22, a communication module 23, and an input/output device 24.

Similarly to the server device 1, the company terminal 2 may be a computer including a processor (e.g., a CPU or a GPU), a main storage device (e.g., a RAM or a ROM), and an auxiliary storage device (e.g., an EPROM, a hard disk drive, or a removable medium). Some or all of the functions (software modules) may be implemented as hardware modules by a hardware circuit such as an ASIC or an FPGA.

The control unit 21 is an arithmetic unit that implements various functions (software modules) of the company terminal 2 by executing a predetermined program. The control unit 21 can be implemented by, for example, a hardware processor such as a CPU. The control unit 21 may include a RAM, a read only memory (ROM), a cache memory, etc.

The storage unit 22 is means for storing information, and is constituted by a storage medium such as a RAM, a magnetic disk, or a flash memory. The storage unit 22 stores programs to be executed by the control unit 21, data to be used by the programs, etc.

The communication module 23 is a communication interface for connecting the company terminal 2 to a network. The communication module 23 may include, for example, a network interface board and a wireless communication interface for wireless communication. The company terminal 2 can perform data communication with other computers (e.g., the server device 1) via the communication module 23.

The input/output device 24 is means for receiving an input operation performed by an operator and presenting information to the operator. Specifically, the input/output device 24 includes input devices such as a mouse and a keyboard, and output devices such as a display and a speaker. The input/output device may be an integrated device such as a touch panel display.

In the specific hardware configuration of the company terminal 2, any component may be omitted, replaced, or added as appropriate depending on embodiments similarly to the server device 1.

### Software Configurations

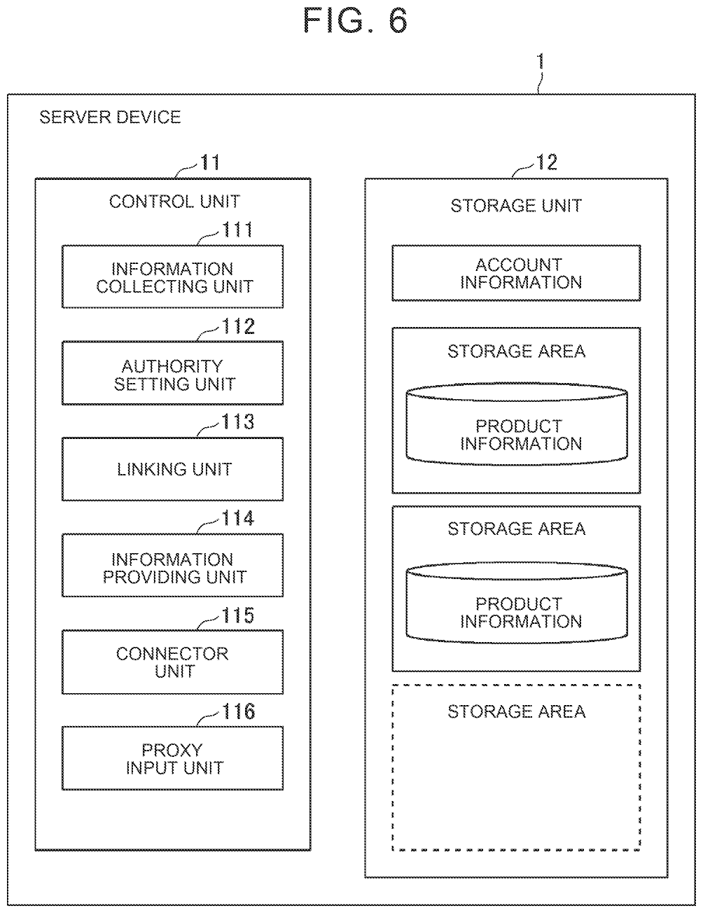

Next, the software configuration of the device constituting the system will be described with reference to FIG. 6. FIG. 6 schematically shows an example of the software configuration of the server device 1 according to the present embodiment. In the present embodiment, the control unit 11 includes six software modules that are an information collecting unit 111, an authority setting unit 112, a linking unit 113, an information providing unit 114, a connector unit 115, and a proxy input unit 116. The software modules may be implemented by the control unit 11 (CPU) executing programs stored in the storage unit 12. Information processing to be executed by the information collecting unit 111, the authority setting unit 112, the linking unit 113, the information providing unit 114, the connector unit 115, and the proxy input unit 116 is synonymous with information processing to be executed by the control unit 11.

The information collecting unit 111 executes a process for receiving product information transmitted from the company terminal 2 and storing the product information in the storage unit 12. The authority setting unit 112 receives information for setting authority to access the product information (hereinafter referred to as “permission information”) from the company terminal 2. The authority setting unit 112 executes a process for setting authority to access the product information stored in the storage unit 12 based on the received information.

The linking unit 113 acquires information for linking pieces of product information from the company terminal 2 by interacting with the company terminal 2. The linking unit 113 executes a process for writing information indicating a linking relationship for the pieces of product information stored in the storage unit 12 based on the acquired information. The linking unit 113 executes a process for receiving a request to assign termination information and, in response to the request, assigning the termination information to the product information stored in the storage unit 12. A product tree is formed by reflecting the linking and termination. That is, the product tree is formed by saving the linking information and the termination information in the storage unit 12. The linking unit 113 generates the product tree based on results of the linking and termination.

The information providing unit 114 executes information processing related to the product tree and outputs a result of executing the information processing. The information processing related to the product tree may include a process for performing calculation on traceability of the product tree. The output of the result of executing the information processing may include a process for providing information on the generated product tree to the company terminal 2. In one example, the information providing unit 114 generates information on the product tree and outputs the generated information on the product tree.

The connector unit 115 includes an application to be used for communication related to platforms. Communication between a plurality of server devices 1 may be performed via the connector unit 115. The connector unit 115 may perform processes related to data communication, such as authentication and encryption of communication. The connector unit 115 may control access to each piece of data based on rules such as laws, regulations, and contracts. In one example, the connector unit 115 may be an application to be used for communication related to platforms, such as an International Data Spaces (IDS) connector or an Eclipse Dataspace Connector (EDC).

The proxy input unit 116 executes a process for receiving product information transmitted from another platform and storing the product information in the storage unit 12.

In the present embodiment, the storage unit 12 includes a plurality of logical storage areas. Different access authorities can be set in the storage areas, such as an area that the company A is authorized to access, an area that the company B is authorized to access, and an area that both the companies A and B are authorized to access. The authority setting unit 112 sets the access authority by storing the product information received from the company terminal 2 in an appropriate storage area. A specific processing method will be described later.

The storage unit 12 stores account information. In the present embodiment, an operator of each company logs into the server device 1 via the company terminal 2 by using an account of the corresponding company to perform interaction between the server device 1 and the company terminal 2. The account information is information on an account associated with each company constituting the supply chain. The login using an account is an example of access to the server device 1 as a corresponding company. The method for accessing the server device 1 is not limited to such an example, and may be selected as appropriate depending on embodiments.

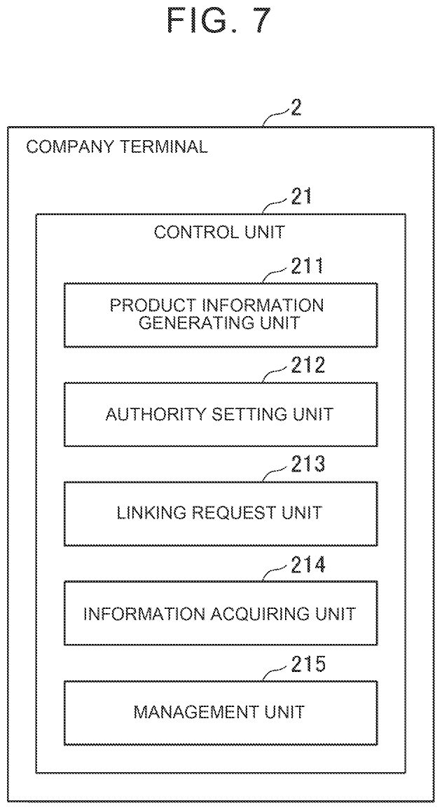

FIG. 7 schematically shows the software configuration of the company terminal 2 according to the present embodiment. In the present embodiment, the control unit 21 includes five software modules that are a product information generating unit 211, an authority setting unit 212, a linking request unit 213, an information acquiring unit 214, and a management unit 215. The software modules may be implemented by the control unit 21 (CPU) executing programs stored in the storage unit 22. Information processing to be executed by the product information generating unit 211, the authority setting unit 212, the linking request unit 213, the information acquiring unit 214, and the management unit 215 is synonymous with information processing to be executed by the control unit 21.

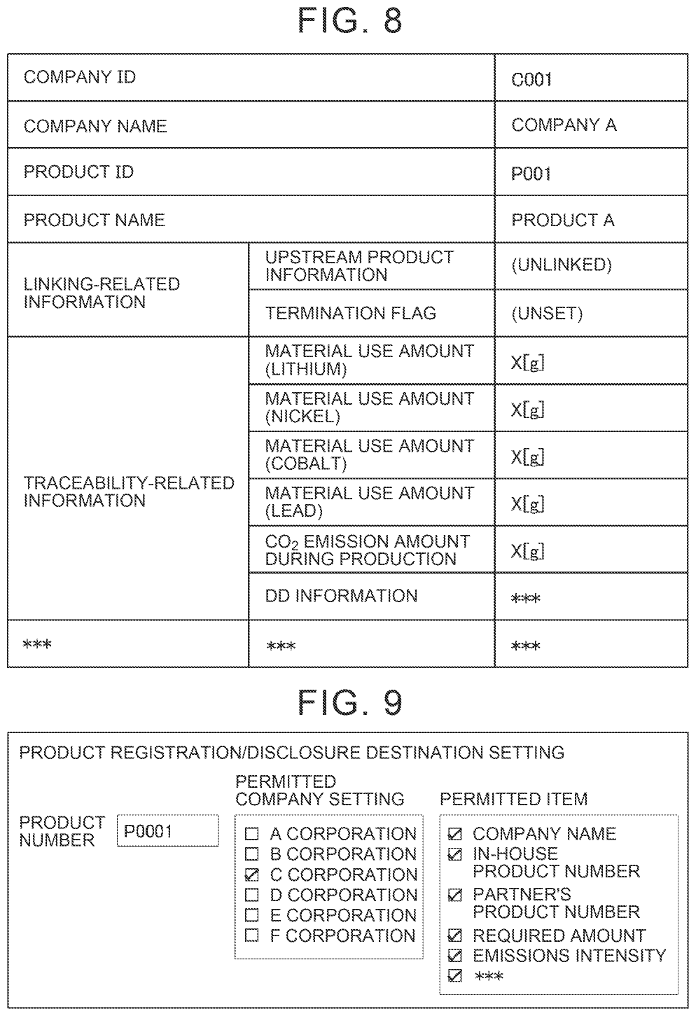

The product information generating unit 211 generates information on a product of a company associated with the company terminal 2 (product information). FIG. 8 shows an example of the product information generated by the product information generating unit 211. The product information may be input via a device operator. In the present embodiment, the product information includes fields for a company identifier (ID), a company name, a product ID, and a product name. The company ID and the company name are an identifier and a name of a company that produces a target product (i.e., the company that uses the company terminal 2). The product ID and the product name are an identifier and a name of the target product.

The product information further includes linking-related information. The linking-related information is information for identifying an upstream product linked to the target product. In the present embodiment, the linking-related information includes fields for “upstream product information” and “termination flag”.

The upstream product information field stores information for identifying product information associated with the upstream product linked to the target product (i.e., a product necessary for producing the target product and incorporated in the target product). The upstream product information field is used when the server device 1 links products. When the product information is generated, the target product is not basically linked to the upstream product. Therefore, the upstream product information field may not store a value indicating the upstream product.

The termination flag field stores a flag indicating whether the target product is a leaf node in the product tree, that is, a node positioned on the most upstream (terminal end) side. In the present embodiment, the plurality of company terminals 2 transmits pieces of product information. Therefore, this flag is used to determine whether an upstream product is linked to a certain product in the product tree or no more products are linked to the certain product (whether the target product is positioned on the most upstream side). That is, the termination flag field is used when the server device 1 finalizes the linking between products. When the product information is generated, the linking relationship of the target product is basically not finalized. Therefore, the termination flag field may store “0 (currently unterminated)” or the termination flag field may be unset. To finally generate the product tree, the status of the product information of each company stored in the server device 1 is set to “linked to upstream product” or “termination flag is set to 1”.

The product information further includes traceability-related information. In one example, the traceability-related information may include amounts of materials (e.g., upstream products) used per production volume of the product, information on a recycling rate of a predetermined raw material, an amount of greenhouse gases emitted when the product is produced (CFP value), due diligence-related information, or a combination thereof. Examples of the predetermined raw material include lithium, nickel, cobalt, lead, and graphite. The recycling rate may be expressed directly or may be expressed indirectly, for example, by a combination of the total use amount and the amount of use of the recycled material. These values are associated with the process of producing the target product. In the example of FIG. 3, the traceability-related information in the product information A stores an amount of greenhouse gases emitted in the production activities of the product A. The traceability-related information in the product information A does not include information on the processes up to the production of the upstream product (e.g., an amount of greenhouse gases emitted until the upstream product B is produced).

The traceability-related information may be selected as appropriate depending on embodiments. In one example, the amount of greenhouse gas emissions (carbon footprint) may include emissions in scope 1, scope 2, and scope 3. Scope 1 may cover an amount of direct greenhouse gas emissions. Scope 2 may cover an amount of indirect emissions along with the use of electricity, heat, and steam supplied by other companies. Scope 3 may cover an amount of indirect emissions other than those in scope 1 and scope 2. In one example, the due diligence-related information may be technical documentation on a product containing a target raw material (e.g., cobalt, natural graphite, lithium, or nickel), indicating that responsible mineral sourcing obligations are met for the amount of the raw material contained in the product, a smelter, etc. In another example, the due diligence-related information may include a score indicating the degree to which the obligations are met.

The product information generating unit 211 acquires such information via the operator of the company terminal 2 and transmits it to the server device 1 at any timing.

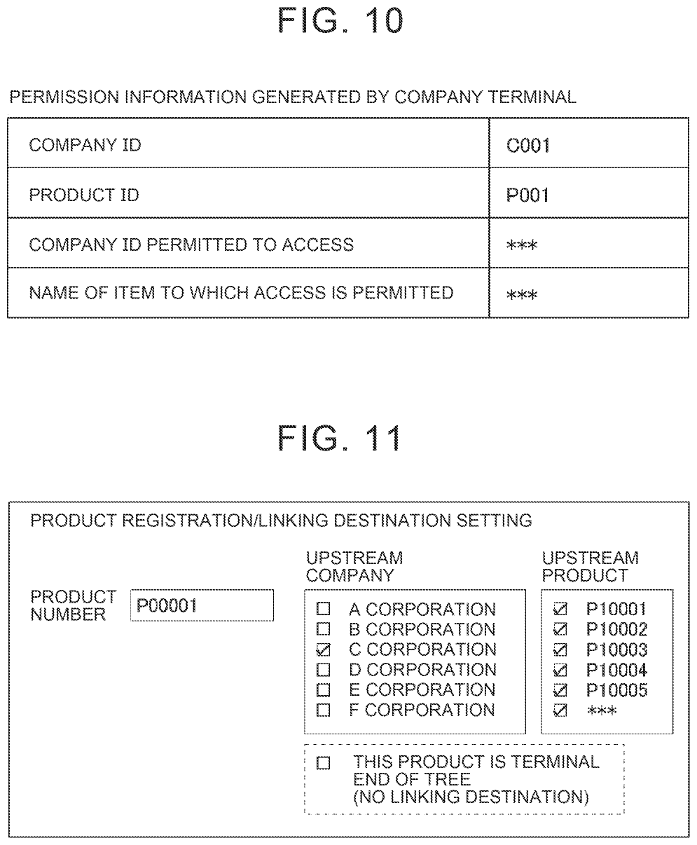

The authority setting unit 212 designates a downstream company that is permitted to access the product information transmitted from the company terminal 2 to the server device 1. FIG. 9 shows an example of a screen output by the authority setting unit 212. As in the illustration, the authority setting unit 212 receives designation of a downstream company that is permitted to access any in-house product. FIG. 10 shows an example of permission information generated by the authority setting unit 212 based on input information. The authority setting unit 212 transmits the permission information to the server device 1 at any timing. The access authority may be set for each piece of product information or may be set for each item in the product information (“permitted item” in the figure). Thus, partial disclosure can be achieved such that the existence of the product is disclosed but specific information on the materials used, the amount used, etc. is not disclosed.

The list of companies presented on the screen of FIG. 9 may be a list of companies that have records of transaction with the company of interest in the past. Therefore, the server device 1 may store data on past transaction (transaction data) for each company and generate the list of companies based on the transaction data. The transaction data may include, for example, an identifier of a target product, an identifier of a company that produced the product, and a date of transaction.

The linking request unit 213 requests the server device 1 to link the in-house product information transmitted to the server device 1 to an upstream product. In one example, the linking request unit 213 first transmits a company ID and a product ID of the company of interest to the server device 1, and requests linking of product information associated with the product ID. The server device 1 generates a user interface including a list of product information (i.e., linking destination candidates) that the target company is permitted to access, and provides the generated user interface to the company terminal 2. FIG. 11 shows an example of the user interface including a list of products that the target company is permitted to access.

The list of products presented in FIG. 11 may be a list of products that have records of transaction with the company of interest in the past. The server device 1 may generate the list based further on the stored transaction data.

Subsequently, the linking request unit 213 prompts the operator to select an upstream product to be linked from the list. The linking request unit 213 transmits, to the server device 1, a pair of an identifier of a linking source product (downstream product) and an identifier of the linking destination upstream product. In response to this, the server device 1 can link the pieces of product information.

When there is no upstream product to be linked to the target product, this fact can clearly be indicated, for example, by marking a checkbox represented by a dashed line in FIG. 11. In this case, pieces of product information are not linked.

The information acquiring unit 214 requests the server device 1 to provide the product tree and outputs the information transmitted from the server device 1. The management unit 215 executes a process for requesting the server device 1 to register product information stored in another platform.

### Details of Process Related to Product Tree Generation

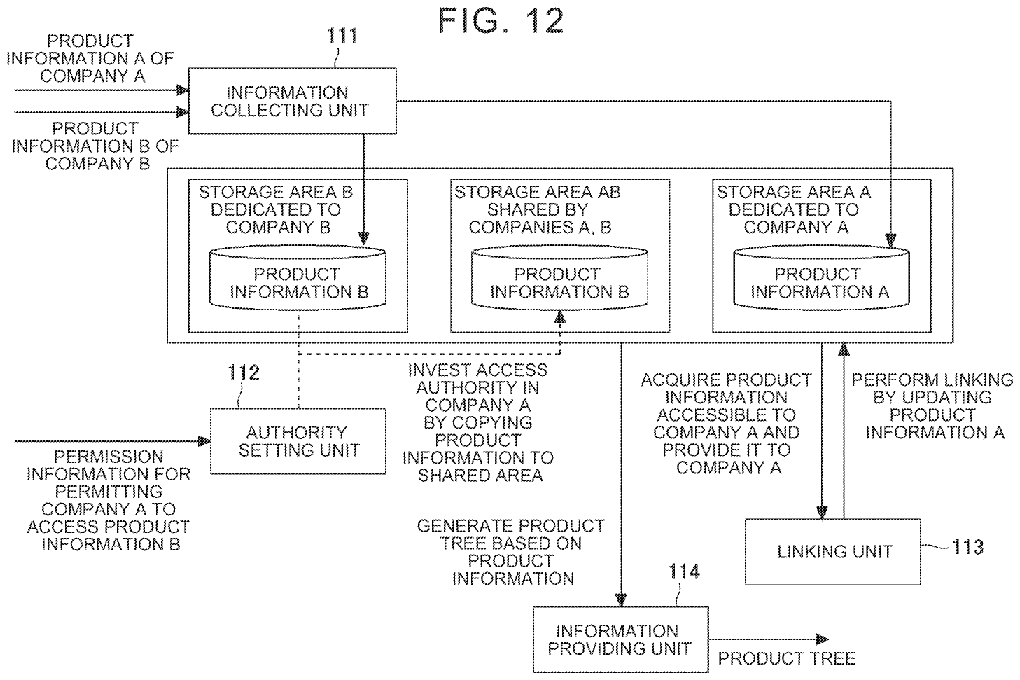

Next, details of a process to be performed by the server device 1 and the company terminal 2 will be described. FIG. 12 shows an example of a flow of a process to be executed by the server device 1 based on a request from the company terminal 2. The process to be performed by the server device 1 can roughly be divided into the following four phases.

(1) First phase for receiving product information transmitted from the company terminal 2 and storing the received product information
(2) Second phase for receiving permission information transmitted from the company terminal 2 and setting authority to access the product information based on the received permission information
(3) Third phase for linking pieces of product information by interacting with the company terminal 2
(4) Fourth phase for providing information on a product tree based on a linking result

In the example of FIG. 12, a company A is a downstream company and a company B is an upstream company. A product produced by the company A will be referred to as “product A”, and a product produced by the company B will be referred to as “product B”. Product information associated with the product A will be referred to as “product information A”, and product information associated with the product B will be referred to as “product information B”.

In the first phase, the information collecting unit 111 of the server device 1 acquires product information from the product information generating unit 211 of the company terminal 2. In the example of FIG. 12, the server device 1 acquires the product information A from the company terminal 2 associated with the company A, and acquires the product information B from the company terminal 2 associated with the company B. The information collecting unit 111 saves the product information A in a storage area that only the company A is authorized to access (hereinafter referred to as “storage area A”). The information collecting unit 111 saves the product information B in a storage area that only the company B is authorized to access (hereinafter referred to as “storage area B”). In this way, the information collecting unit 111 saves the product information transmitted from any company in a dedicated storage area that only the company is authorized to access.

In the second phase, the authority setting unit 112 of the server device 1 receives permission information from the authority setting unit 212 of the company terminal 2. The authority setting unit 112 sets authority to access the product information based on the received permission information. As shown in FIG. 10, the permission information is information in which a product is associated with a company permitted to access product information of the product.

In the example of FIG. 12, it is assumed that the authority setting unit 112 receives permission information indicating that the downstream company A is permitted to access the product information B of the upstream company. In this case, the authority setting unit 112 copies the product information B stored in the storage area B to a storage area that both the companies A and B are authorized to access (hereinafter referred to as “storage area AB”). Thus, the product information B is accessible to both the company A and the company B. When no access authority is set for a specific item in the product information, the item is excluded from the target of copy to the storage area AB.

In the following description, a storage area that only a specific company is authorized to access will be referred to as “dedicated storage area”, and a storage area that a plurality of companies is authorized to access will be referred to as “shared storage area”.

The server device 1 copies the product information in response to reception of the permission information from the company terminal 2. That is, the company terminal 2 transmits the permission information to the server device 1 to cause the server device 1 to copy the product information identified by the permission information from the dedicated storage area of the target company to the shared storage area accessible to the downstream company.

In the third phase, the linking unit 113 of the server device 1 receives a linking request from the linking request unit 213 of the company terminal 2, and links the pieces of product information based on the received linking request.

First, the linking unit 113 receives the linking request from the company terminal 2. The linking request is transmitted from the company terminal 2 of the downstream company. In the example of FIG. 12, it is assumed that the company terminal 2 of the company A transmits the linking request. The linking request includes a company ID and a product ID of a target product. The linking unit 113 acquires product information stored in the storage area accessible to the company, and generates a list of the acquired product information. In the example of FIG. 12, the company A can access the product information B stored in the storage area AB. Therefore, the product information B can be selected as a linking destination in the company terminal 2 of the company A.

The linking request unit 213 of the company terminal 2 presents the list to an operator, and prompts the operator to select products to be linked. In this example, the product A and the product B are linking targets. For example, the operator inputs, via the input/output device 24, information indicating that the product B is an upstream product for the product A. The linking request unit 213 transmits data (linking data) for associating the upstream product (product B) and the downstream product (product A) with each other to the linking unit 113.

As described with reference to FIG. 8, the product information includes the field related to the product to be linked (linking-related information). Based on the linking data, the linking unit 113 stores information associated with the product information B (i.e., the upstream product) in the linking-related information of the product information A. For example, the linking-related information stores an identifier of the upstream product and an identifier of the company that produces the upstream product.

The linking-related information may store, for example, a pointer to the linking destination product information. The pointer indicates, for example, an address of the product information associated with the upstream product. Through the process described above, a part of the tree structure is formed with the product information of the downstream product as a parent node and the product information of the upstream product as a child node.

No further linking is performed at the terminal end of the product tree. In this case, the linking request unit 213 transmits data indicating that the product is the terminal end of the tree instead of transmitting the linking data. When the data is received, the linking unit 113 sets “1” in the termination flag field of the corresponding product information. That is, the “process for setting linking destination upstream product” or the “process for setting termination flag” is executed in the third phase.

In the fourth phase, the information providing unit 114 of the server device 1 generates information on the product tree based on the stored pieces of product information, and outputs the information on the product tree. The generation of the information on the product tree can include, for example, a process for generating various types of information on the products (e.g., information on traceability and an image showing the linking relationship among the products in a tree diagram) after links between nodes are formed by linking the pieces of product information. To generate the information on the product tree, it is necessary that all the pieces of product information have been linked and the termination flags of all the leaf nodes have been set to “1”. The information providing unit 114 can appropriately generate the information when such conditions are satisfied.

As described with reference to FIG. 2, the product tree in the present embodiment is a tree diagram showing the supply relationships among the pieces of product information in the supply chain. The information providing unit 114 can generate the image showing the tree diagram based on the pieces of product information.

When generating the information on the product tree, the information providing unit 114 integrates the pieces of traceability-related information defined in the pieces of product information, and outputs a result of the integration.

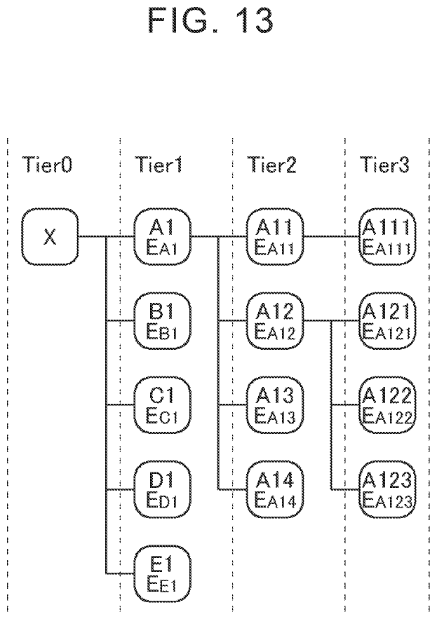

The integration of the pieces of traceability-related information will be described with reference to FIG. 13. FIG. 13 illustrates a plurality of products constituting the final product X and the amounts of carbon dioxide (CO₂) emitted in individual processes for producing the products. For example, it is assumed that E_{A12} [g] of carbon dioxide is emitted in a process for producing the product A12 in the figure. It is also assumed that this product is composed of three upstream products A121 to A123. An upstream product included in a certain product will be referred to also as “incorporated product”. The total amount of carbon dioxide emitted until a certain target product is produced can be obtained by repeating a process of transferring the amount of CO₂ emission associated with an upstream product to a downstream product between companies at two adjacent hierarchical levels from the most upstream product at the leaf node to the target product.

When the target product is A12 in the example of FIG. 13, the total amount of carbon dioxide emitted until the product A12 is produced can be calculated by summing the amounts of CO₂ emission associated with the incorporated products (upstream products A121 to A123) and the amount of CO₂ emission associated with the product A12. That is, the integrated amount of CO₂ emission for the product A12 is as follows.

I_{A12}=E_{A12}+E_{A121}×U_{A121}+E_{A122}×U_{A122}+E_{A123}×U_{A123}[g]

In this expression, E_{A121}, E_{A122}, and E_{A123} are CO₂ emissions per unit amount when the products A121, A122, A123 are produced, respectively. Further, U_{A121}, U_{A122}, and U_{A123} are the amounts of use of the products A121, A122, A123 in the production of the product A12, respectively. This use amount is an example of the amount of material used per production volume of the product in the traceability-related information. The amount of CO₂ emission of the final product (product of the most downstream company) can be obtained by sequentially executing the above calculation from the product of the most upstream company to the final product.

The same applies to a case where the target product is the product A1. When the target product is A1, the total amount of carbon dioxide emitted in the manufacturing activities until the product A1 is produced can be calculated by integrating the amount of CO₂ emission associated with the product A1 and the amounts of CO₂ emission associated with the incorporated products A11, A12, A13, A14.

The integrated value may be stored in the storage unit 12 in association with the product or may be included as a part of the product information. That is, the product information associated with the product A12 may hold both E_{A12} that is the emission amount in the process alone and I_{A12} that is the integrated emission amount.

Post-integration traceability-related information is reused when performing integration for a downstream product. By executing this process at each hierarchical level starting from the most upstream side, the traceability-related information (e.g., the cumulative value of the amounts of CO₂ emission) is sequentially transferred in the downstream direction. When the traceability-related information is finally transferred to the final product, the traceability-related information associated with the entire period until the final product is produced (e.g., the total amount of CO₂ emission) can be obtained.

In this way, when generating the information on the product tree, the information providing unit 114 may repeat the process of sequentially integrating the pieces of traceability-related information defined in the pieces of product information from the most upstream side to the most downstream side. In the above example, the amount of carbon dioxide emission is exemplified as the integration target, but the traceability-related information that is the integration target may be a recycling rate related to a predetermined raw material, a score related to due diligence, etc. When the traceability-related information is a numerical value, the integration may be performed by numerical calculation. When the traceability-related information is non-numerical information (e.g., due diligence-related information), the integration may simply be information collection.

In another example, the product information may include information indicating the location of the traceability-related information of the corresponding product (hereinafter referred to as “location information”: typically address or pointer). In this case, the traceability-related information may not be included in the product information. The integration may be collection of the location information included in the product information.

The information providing unit 114 may output the generated product tree in an image format. The information providing unit 114 may simultaneously output the traceability-related information associated with any product.

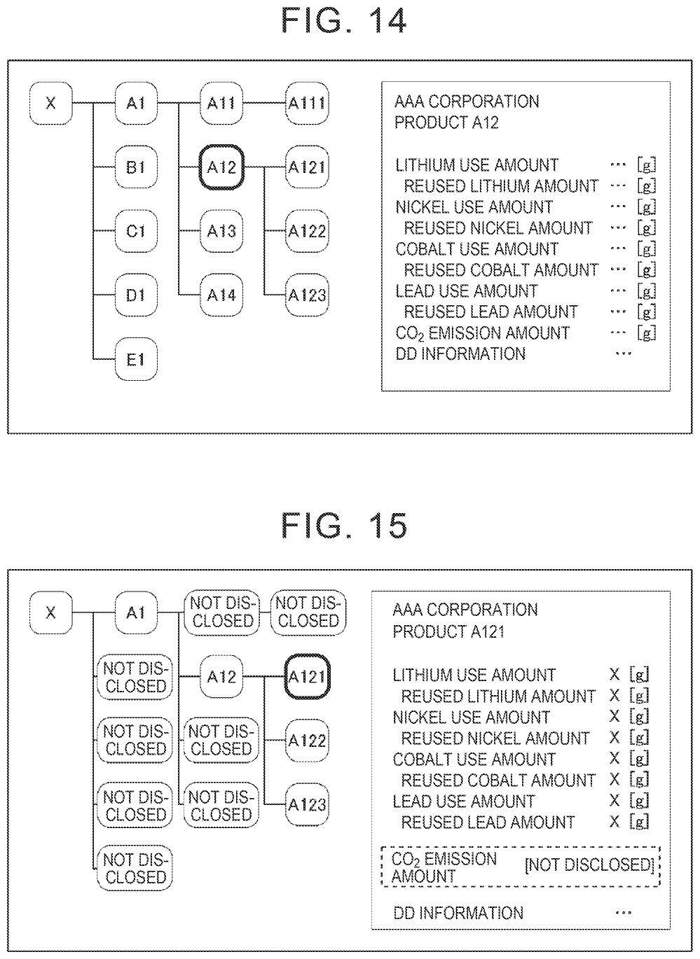

FIG. 14 shows an example of a screen in which the product tree is output as an image. The illustrated screen includes an image showing a tree diagram of the supply relationships among the products constituting the final product. When any product is selected, the traceability-related information associated with the product or the result of the integration of the pieces of traceability-related information associated with the entire period until the product is produced (e.g., the total amount of carbon dioxide emission from the most upstream side) can be viewed. Such information can be output via the input/output device 14 of the server device 1 based on an operation performed by the operator of the server device 1.

The information providing unit 114 may provide the generated product tree to the company terminal 2 in response to a request by the company terminal 2 (information acquiring unit 214). It may be inappropriate to disclose the entire product tree to a specific company. Therefore, when providing the product tree to the company terminal 2 associated with a certain company, the information providing unit 114 may perform a process for hiding a range that the company is not authorized to access.

In the example of FIG. 13, it is assumed that the information providing unit 114 receives a product tree disclosure request transmitted by the company terminal 2 associated with the company that produces the product A12. It is assumed that the company is authorized to access only the products A121, A122, A123. That is, the company cannot access product information other than those of the three products and the downstream product A1. In this case, the information providing unit 114 provides the company terminal 2 with the product tree in which pieces of information on products without access authority are hidden.

FIG. 15 shows an example of the product tree in the case where the products without access authority are hidden. In this example, the product tree is displayed with detailed information (or existence) concealed for undisclosed products.

In a case where the existence of a product is disclosed but access authority is not invested only for a specific item in the corresponding product information, the concealing process is performed only on the specific item as indicated by a dotted line in the figure. In the illustrated example, the amount of carbon dioxide emission when the product A121 is produced is hidden.

Even if the tree includes products (or items) without access authority, the pieces of traceability-related information are integrated without being affected by this. In the illustrated example, the amount of carbon dioxide emission for the product A121 is hidden, but the process of calculating the total amount of carbon dioxide emission for the product A12 is not affected.

### Processing Flow

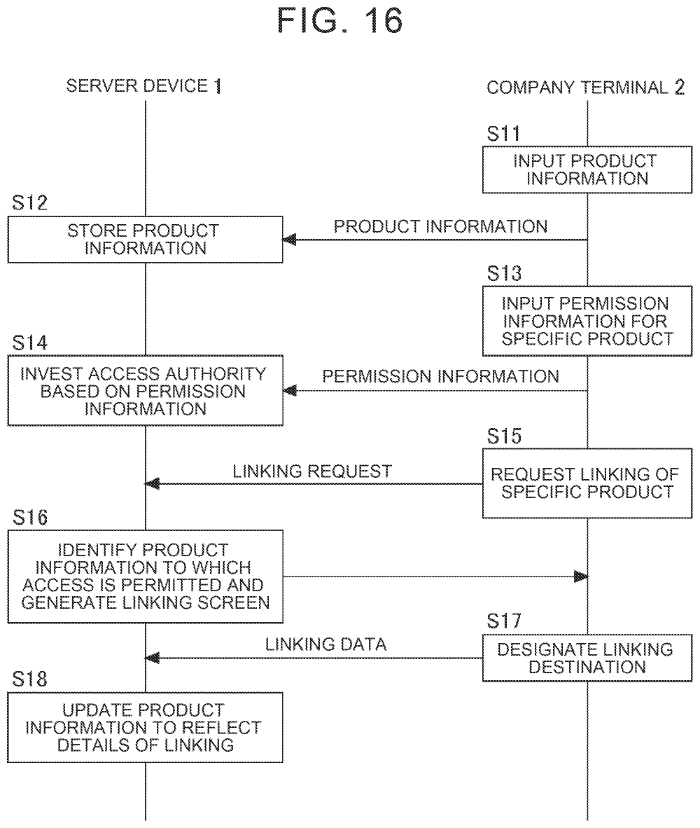

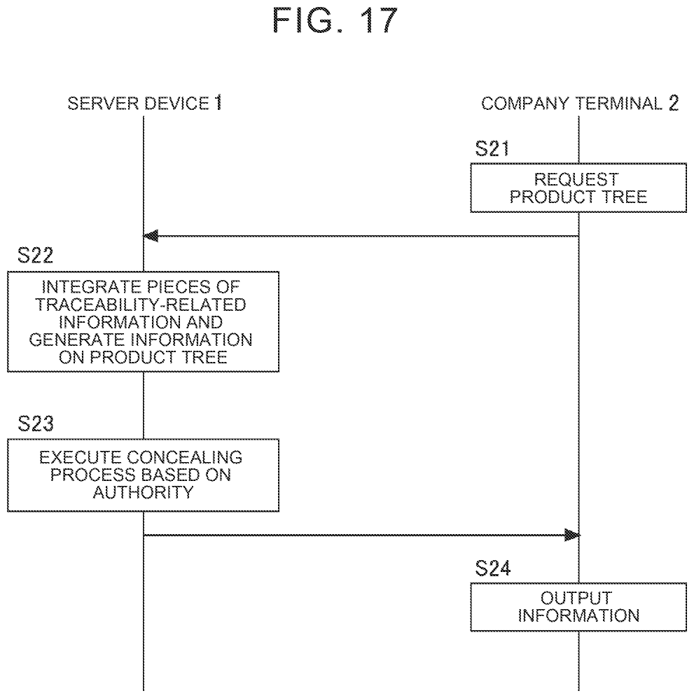

Next, a flow of a process to be executed by the server device 1 and the company terminal 2 when in-house product information is registered by the company terminal 2 will be described with reference to FIGS. 16 and 17. FIG. 16 is a sequence diagram corresponding to the first to third phases.

In one example, the interaction between the server device 1 and the company terminal 2 is started when the operator of each company logs into the server device 1 via the company terminal 2 by using the account of the corresponding company. In this example, it is assumed that the operator of each company logs into the server device 1 by using the company's account.

In step S11, the product information generating unit 211 of the company terminal 2 first acquires the in-house product information via the operator, and transmits the acquired product information to the server device 1. The transmitted product information is received by the server device 1 (information collecting unit 111) and stored in the storage unit 12 (step S12). At this time, the information collecting unit 111 saves the product information in a storage area that only the company that produces the corresponding product is authorized to access.

In step S13, the authority setting unit 212 of the company terminal 2 receives, via the operator, input of information for designating a downstream company permitted to access the product information transmitted in step S11 (permission information). In this step, the user interface screen described with reference to FIG. 9 may be provided to designate a combination of any product and a downstream company permitted to access the product information. The input permission information is transmitted to the server device 1.

In step S14, the authority setting unit 112 of the server device 1 invests authority to access the target product information based on the received permission information. In this step, as described with reference to FIG. 12, the authority setting unit 112 invests any company with authority to access any product information by copying the target product information to a storage area that a plurality of companies is authorized to access. When there is no storage area with appropriate access authority, a process of generating a new storage area and investing access authority in an appropriate company may be performed.

In step S15, the linking request unit 213 of the company terminal 2 transmits data for requesting the server device 1 to link the product information transmitted to the server device 1 to an upstream product (linking request). The linking request includes a company ID of the company and a product ID of the target product.

In step S16, the server device 1 (linking unit 113) generates a list of product information that the target company is permitted to access, and provides the company terminal 2 with a user interface screen including the list. In this step, the server device 1 may provide the company terminal 2 with the user interface screen described with reference to FIG. 11 to designate a combination of any product and an upstream product to be linked to the product.

In step S17, the linking request unit 213 of the company terminal 2 receives, from the operator, designation of a combination of the target product and the upstream product to be linked to the target product. The linking request unit 213 generates data indicating association between the upstream product and the downstream product (linking data), and transmits the generated linking data to the server device 1.

In step S18, the linking unit 113 of the server device 1 updates the stored pieces of product information based on the linking data, to reflect the details of the linking between the pieces of product information. The pieces of product information may be linked by storing information (identifier, pointer, etc.) on the upstream product in the linking-related information included in the product information of the downstream product.

When there is no downstream company, the process of steps S13 and S14 may be omitted. Similarly, when there is no upstream company (when there is no linking destination for the target product), the process of setting the termination flag may be executed instead of requesting the linking of pieces of product information. In this case, the process of steps S15 to S18 is omitted.

FIG. 17 is a sequence diagram corresponding to the fourth phase. In step S21, the information acquiring unit 214 of the company terminal 2 first requests the server device 1 to provide a product tree. The request includes, for example, an identifier of the target product. The target product may be a final product or any other product (intermediate product).

The server device 1 (information providing unit 114) that has received the request generates information on the product tree through the above process (step S22). At this time, the information providing unit 114 executes the process of integrating pieces of traceability-related information defined in the pieces of product information from the most upstream side to the most downstream side. The result of the integration may be reflected in each piece of product information.

In step S23, the server device 1 executes the process of concealing information without access authority based on the access authority invested in the target company. For example, when the existence of product information of another company is not disclosed for a certain company, the server device 1 may execute a process of concealing the existence of the product information. When only a specific item in the product information is not disclosed, the server device 1 may execute a process of concealing details of the item. Information on the product tree subjected to the concealing process is provided to the company terminal 2 (information acquiring unit 214) and is output (step S24).

### Details of Process for Registering Product Information on Other Platform

The proxy input unit 116 of the server device 1 can acquire product information from a server device 1 of another platform and store it in the storage unit 12. If product information stored on another platform can be used when product information is newly stored on the platform, the operator of the company terminal 2 can reduce time and effort required to input the information. In the present embodiment, based on a request from a company that has already registered product information in another supply chain, the product information of that company is registered in a supply chain of interest.

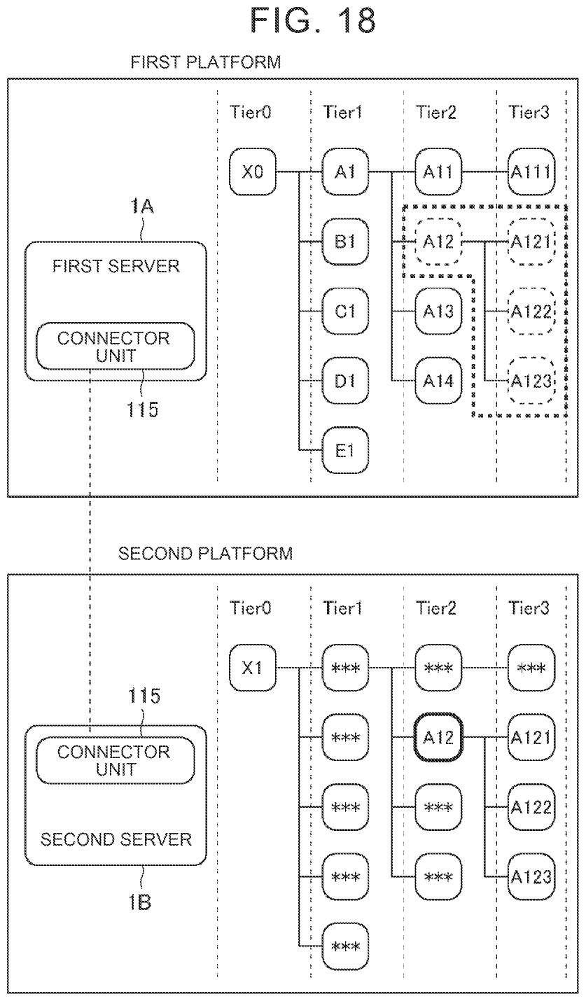

FIG. 18 illustrates an example of a relationship between products in two supply chains. It is assumed that the two supply chains are formed on a first platform and a second platform. In FIG. 18, a tree diagram on the first platform shows supply relationships among a plurality of products constituting a final product X0. A tree diagram on the second platform shows supply relationships among a plurality of products constituting a final product X1. For example, the first platform and the second platform are formed in different countries or regions. The server device 1 associated with the first platform will hereinafter be referred to as “first server device 1A”, and the server device 1 associated with the second platform will hereinafter be referred to as “second server device 1B”. The first server device 1A and the second server device 1B can communicate with each other via the connector units 115. However, the communication via the connector units 115 is not essential, and communication without the connector units 115 may be employed.

The product A12 and the products A121, A122, A123 are registered on the second platform but not registered on the first platform. The products A121, A122, A123 are upstream products for the product A12. The product A12 on the downstream side will hereinafter be referred to as “first product A12”, and the product A121 positioned one level upstream of the first product A12 will hereinafter be referred to as “second product A121”. Since the products A122, A123 can be considered similarly to the second product A121, the second product A121 will be described below.

Description will be given of an exemplary case where the first product A12 will be registered on the first platform. The proxy input unit 116 of the first server device 1A receives a request to register the first product A12 from the management unit 215 of the company terminal 2 of the company that manufactures the first product A12. The company that manufactures the first product A12 will hereinafter be referred to as “first company”, and the company that manufactures the second product A121 will hereinafter be referred to as “second company”. The company terminal of the first company will be referred to as “first company terminal 2A”, and the terminal of the second company will be referred to as “second company terminal 2B”.

The management unit 215 of the first company terminal 2A first requests the first server device 1A to acquire first product information from the second platform and register it on the first platform. At this time, the proxy input unit 116 of the first server device 1A receives identification information of the first product A12 of the first company and information on the second platform from the management unit 215 of the first company terminal 2A. The identification information of the first product A12 is, for example, information including a product ID and a product name stored on the second platform.

The proxy input unit 116 of the first server device 1A transmits, to the second server device 1B, a disclosure request to disclose the information on the first product A12. Transmission and reception of the disclosure request are performed via the respective connector units 115. The disclosure request includes the identification information of the first product A12. The disclosure request also includes, for example, a request to disclose traceability-related information. The disclosure request may include information from which determination can be made as to what type of information to disclose by the request (e.g., information indicating items that is a target for the disclosure request). Since the information required on the first platform and the second platform may differ, disclosure may be requested only for the information required on the first platform. The disclosure request may also include a request to disclose information on a product on the upstream side of the first product A12 (i.e., the second product A121).

The proxy input unit 116 of the second server device 1B that has received the disclosure request identifies the first product A12 based on the identification information. As a response to the disclosure request, the proxy input unit 116 of the second server device 1B transmits information on the first product A12 and information on the second company (hereinafter also referred to as “second company information”) to the first server device 1A. Transmission and reception of the information at this time are also performed via the respective connector units 115. The information on the first product A12 may include information on a disclosure range, such as access authority. The second company information may include, for example, contact information of the second company and information on the second product A121.

When the information on the first product A12 is received from the second server device 1B, the proxy input unit 116 of the first server device 1A stores the information on the first product A12 in the storage unit 12 in association with the first company. In this way, the information on the first product A12 can be registered on the first platform when the first company applies for the registration of the first product A12. This eliminates the need for the first company to input the information on the first product A12 to the first platform by themselves, thereby the time and effort required for the input is reduced.

When the second company information is received from the second server device 1B, the proxy input unit 116 of the first server device 1A performs at least one of generation of a temporary account on the first platform for the second company and registration of the second company information on the first platform in association with the first company. When the temporary account associated with the second company is generated, the proxy input unit 116 of the first server device 1A stores account information of the temporary account associated with the second company in a database constructed in the storage unit 12. Unlike a regular account, the temporary account is subject to restrictions on use of the functions on the first platform. For example, access to pieces of product information of other companies may be blocked. For example, display of the product tree screen may be prohibited. The proxy input unit 116 of the first server device 1A may generate a storage area that the temporary account of the second company is authorized to access. Both the first company and the second company may be authorized to access this storage area.

The proxy input unit 116 of the first server device 1A may store second product information in the storage unit 12 when the second product information is received from the second server device 1B. If the second company does not participate in the first platform when the information on the second product A121 is registered on the first platform, a problem arises in terms of an entity that manages the information on the second product A121 on the first platform. For example, when there is a change in the traceability-related information of the second product A121, there is a possibility that the information is not updated unless a procedure for changing the information is determined. For example, the first company may manage the information by associating the second product information of the second product A121 with the first company. That is, the first company may be registered as a manager of the second product A121. In this case, the second product A121 may be registered as a product of the first company. For example, in the product information shown in FIG. 8, a company ID and a company name associated with the first company may be stored in the fields for the company ID and the company name.

However, time and effort increase for the first company to manage the information on the second product A121 that is not an in-house product. Therefore, the first company may be free of liability for management of the information on the second product A121 registered by the proxy input unit 116 of the first server device 1A. For example, the first server device 1A may hold inquiries for the second company, and send the inquiries to the second company, for example, at predetermined intervals to update the information.

The second product information is not limited to this, and may be stored in the first server device 1A so that determination can be made that the second product information has been registered along with the registration of the first product information. For example, a company ID and a company name that indicate that the first company is a proxy applicant and that are different from the company ID and the company name of the first company may be stored in the fields for the company ID and the company name in the second product information. The proxy applicant is a company that applies for registration of information on a product other than the in-house product. For example, when the second product information is registered along with the registration of the first product information, the first company is registered as the proxy applicant by being regarded as the first company having applied for proxy registration of the second product information. The proxy applicant is free of liability for management after the second product information has been stored. As another method, the proxy input unit 116 may generate a company ID associated with the second company, input the company ID and a company name associated with the second company in the fields for the company ID and the company name, and store the company ID and the company name of the first company by providing fields for storing the company that has made a proxy application. As still another method, the fields for the company ID and the company name may be left blank and the company ID and the company name of the first company may be stored by providing fields for storing the company that has made a proxy application.

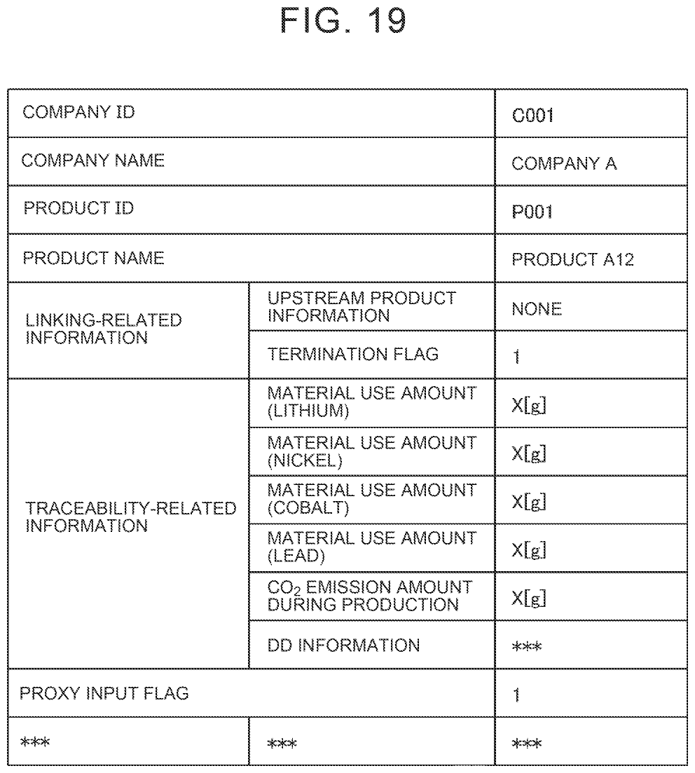

In order to identify the product information registered by the first server device 1A based on the information received from the second server device 1B, the product information stored in the first server device 1A may have a proxy input flag field. FIG. 19 shows an example of the product information generated by the information collecting unit 111 or the proxy input unit 116. The proxy input flag field is used to identify the product information registered by the first server device 1A. A value “1” is stored in the proxy input flag field when the registration is performed by the first server device 1A, and a value “0” is stored in the proxy input flag field when the registration is performed based on the product information transmitted from the company terminal 2. Therefore, when the product information acquired from the company terminal 2 is stored in the storage unit 12, the information collecting unit 111 stores the value “0” in the proxy input flag field. When the first product information and the second product information acquired from the second server device 1B are stored in the storage unit 12, the proxy input unit 116 stores the value “1” in the proxy input flag field.

FIG. 20 shows a case where a storage area associated with the temporary account of the second company is generated in the storage unit 12. The storage area associated with the temporary account of the second company may be allocated in this way. As another method, the proxy input unit 116 of the first server device 1A may only generate the temporary account linked to the second company without allocating the storage area to the second company. The proxy input unit 116 of the first server device 1A may store the second product information in the storage area associated with the temporary account when the second product information is received from the second server device 1B. The stored second product information may be modifiable only by the temporary account, or may be modifiable by the temporary account and the account of the first company. The proxy input unit 116 of the first server device 1A invests the first company with authority to access the second product information. The proxy input unit 116 of the first server device 1A stores the identification information of the second product A121 in the upstream product information field in the product information of the first product A12.

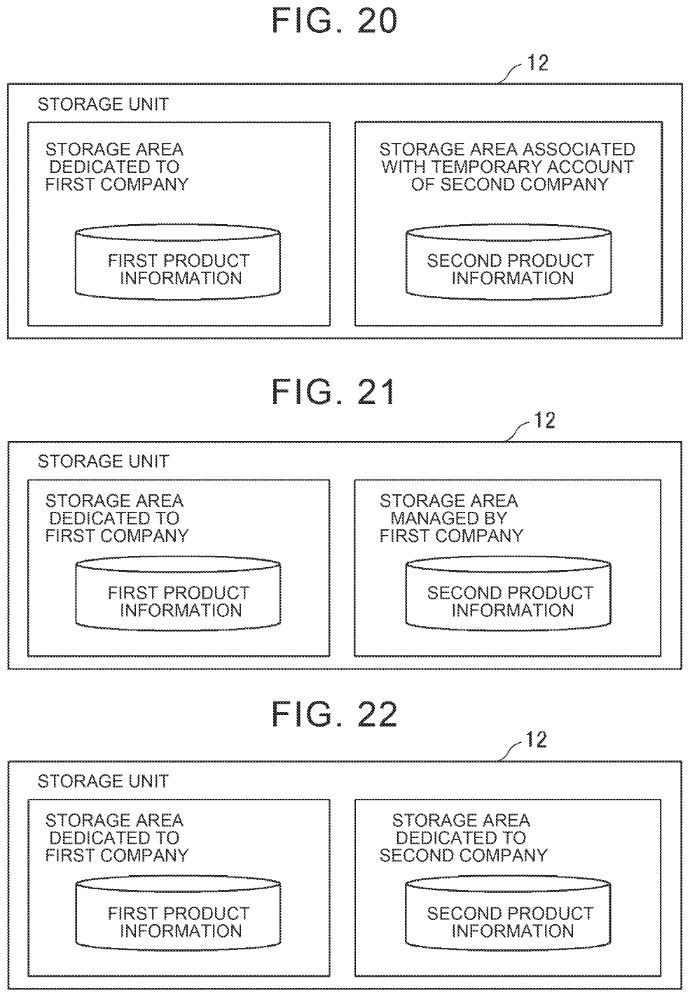

FIG. 21 shows a case where a storage area is allocated so that the information on the second product A121 is managed by the first company. When the second product information is received from the second server device 1B, the proxy input unit 116 of the first server device 1A allocates a storage area with the second product information regarded as product information of a virtual company. Then, the second product information is stored in this storage area. This storage area is associated with the first company and registered as a storage area managed by the first company. For the second product information stored in the first server device 1A, the first company is registered as the manager or the proxy applicant. The proxy input unit 116 of the first server device 1A invests the first company with authority to access the second product information. The proxy input unit 116 of the first server device 1A stores the identification information of the second product A121 in the upstream product information field in the product information of the first product A12.

When the second company participates in the first platform after the second product information has been stored in the storage unit 12 of the first server device 1A, the second company terminal 2B transmits a participation request to the first server device 1A. The participation request includes information on the participation of the second company in the first platform. The proxy input unit 116 of the first server device 1A that has received the participation request formally registers the second company, and allocates the storage area associated with the second product information managed by the first company to the second company. When the temporary account is given, the temporary account is assigned to the second company as a regular account.

FIG. 22 shows the storage unit 12 when a storage area is allocated to the second company. By causing the second company to take over the “storage area managed by the first company” in FIG. 21, it is possible to save the time and effort required to input the second product information again. The second company may take over the “storage area associated with the temporary account of the second company” in FIG. 20 as a storage area dedicated to the second company.

The proxy input unit 116 of the first server device 1A that has received the second company information may contact the second company to prompt the second company to participate in the first platform. This contact may be transmitted to the second company terminal 2B, or may be made by mailing a letter or the like. With this contact, the proxy input unit 116 of the first server device 1A may notify the second company about the temporary account. As another method, the first company may be requested to contact the second company. Since the contact information of the second company may be stored in the second server device 1B, the proxy input unit 116 of the first server device 1A may receive information on the contact information of the second company from the second server device 1B as a response to the disclosure request. As still another method, when the proxy input unit 116 of the second server device 1B transmits the second company information to the first server device 1A, the proxy input unit 116 may contact the second company to prompt the second company to participate in the first platform.

The proxy input unit 116 of the first server device 1A invests authority to access the first product information based on permission information indicating the disclosure range of the first product that is received from the second server device 1B. As described with reference to FIG. 12, the proxy input unit 116 of the first server device 1A invests any company with authority to access any product information by copying the first product information to a storage area that a plurality of companies is authorized to access. For example, the proxy input unit 116 of the first server device 1A stores the identification information of the first product A12 in the upstream product information field in the product information of the upstream product A1.

The proxy input unit 116 of the first server device 1A invests authority to access the second product information based on the second company information received from the second server device 1B. For example, only the first company may be authorized to access the second product information received from the second server device 1B. As described with reference to FIG. 12, the proxy input unit 116 of the first server device 1A invests the first company with authority to access the second product information by copying the second product information to a storage area that the first company is authorized to access.

Information on a product positioned further upstream of the second product A121 can also be transmitted to the first server device 1A together with the first product information, and can be processed as in the case of the second company. For authority to access the pieces of product information including the second product information, for example, access authority designated on the second platform can be transferred.

### Processing Flow

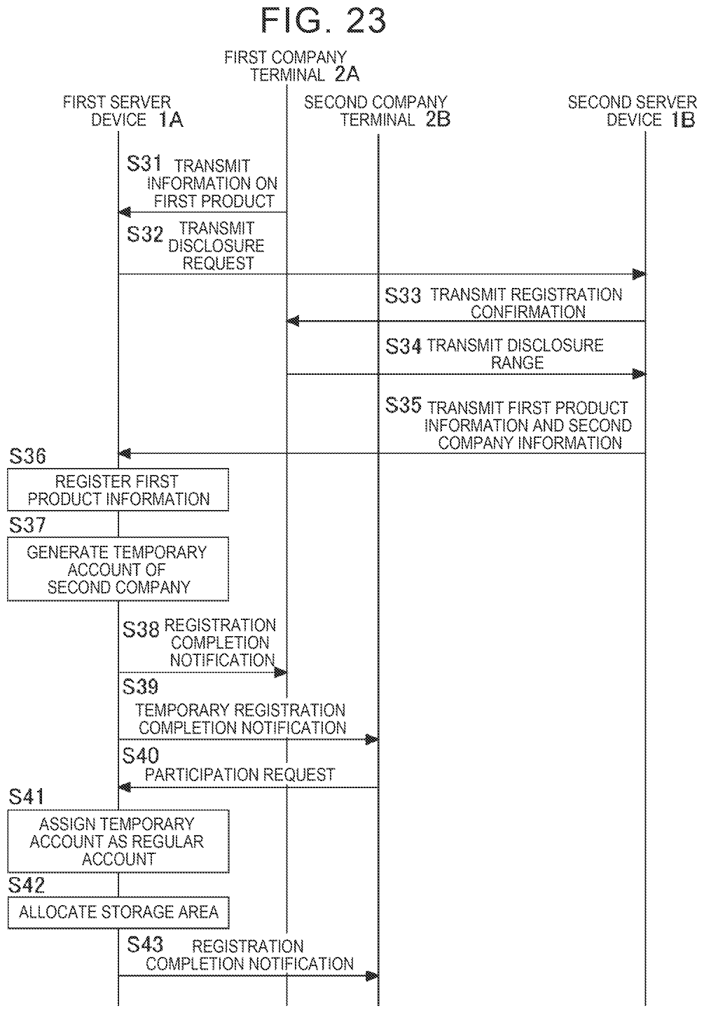

FIG. 23 is a sequence diagram showing an example of a flow of a process in which the first server device 1A acquires the first product information and the second company information from the second server device 1B.

In one example of the present embodiment, it is assumed that the interaction between the server device 1 and the company terminal 2 is started when the operator of each company logs into the server device 1 via the company terminal 2 by using the account of the corresponding company. In this example, it is assumed that the operator of each company logs into the server device 1 by using the company's account. It is also assumed that the first product information and the second product information are linked and stored in the second server device 1B as a downstream product and an upstream product.

The management unit 215 of the first company terminal 2A transmits information on the first product A12 to the first server device 1A via the operator (step S31). The information on the first product A12 includes information to be used by the proxy input unit 116 of the first server device 1A to acquire the product information of the first product A12 from the second server device 1B. In one example, the information on the first product A12 includes the identification information of the first product A12 and the information on the second platform (may be the second server device 1B).

In step S32, the proxy input unit 116 of the first server device 1A transmits a disclosure request to the second server device 1B. This disclosure request is a request for disclosure of the product information of the first product A12, and includes the identification information of the first product A12. The disclosure request also includes a request for disclosure of the information on the second company that is the company of the upstream product for the first product A12. The proxy input unit 116 of the first server device 1A identifies the destination of the disclosure request based on the information on the second platform in the information received from the first company terminal 2A, and transmits the disclosure request.

The proxy input unit 116 of the second server device 1B that has received the disclosure request transmits a registration confirmation to the first company terminal 2A (step S33). The registration confirmation includes an inquiry about whether the product information of the first product A12 may be disclosed to the first server device 1A, and an inquiry about a disclosure range. The disclosure range defines a company to be authorized to access the product information, and is information for designating which company to invest the access authority.

The disclosure range may be included in the information transmitted from the management unit 215 of the first company terminal 2A to the first server device 1A in step S31. The disclosure range may be included in the disclosure request transmitted from the proxy input unit 116 of the first server device 1A to the second server device 1B in step S32. In this case, the proxy input unit 116 of the second server device 1B may present the received disclosure range to the first company terminal 2A and inquire whether to accept the disclosure range. The operator of the first company terminal 2A may modify the disclosure range presented at this time. As another method, when the disclosure range is transmitted from the first server device 1A to the second server device 1B, it is not necessary to inquire the disclosure range in step S33. In this case, the process of steps S33 and S34 is omitted.

The proxy input unit 116 of the second server device 1B may provide a user interface screen that allows the operator of the first company to designate a downstream company to be permitted to make access, thereby designating the downstream company to be permitted to access the first product information. Information on the downstream company at this time is included in the disclosure request.

The management unit 215 of the first company terminal 2A receives, for example, input of acceptance to disclose the first product information to the first server device 1A and information for designating the downstream company to be permitted to make access (permission information). The management unit 215 of the first company terminal 2A acquires, via the operator, the acceptance to disclose the first product information to the first server device 1A and the permission information, and transmits them to the second server device 1B (step S34).

The proxy input unit 116 of the second server device 1B transmits the first product information and the second company information to the first server device 1A as a response to the disclosure request (step S35). At this time, the permission information associated with the first product A12 is also transmitted. The second company information may be transmitted only when the first server device 1A is requested, or determination may be made in advance to transmit the second company information as well when the first product information is transmitted.

The transmitted first product information and permission information are received by the proxy input unit 116 of the first server device 1A and stored in the storage unit 12 (step S36). The proxy input unit 116 of the first server device 1A stores the first product information in the storage unit 12 in association with the first company. At this time, a proxy input flag field is generated and a value “1” is stored in the proxy input flag field. The proxy input unit 116 of the first server device 1A invests authority to access the first product information based on the received permission information. In this step, the proxy input unit 116 invests a company of a downstream product A with authority to access the first product information by copying the first product information to, for example, a storage area that the company of the product A is authorized to access.

The proxy input unit 116 of the first server device 1A generates a temporary account associated with the second company based on the second company information (step S37). When the second product information is included in the second company information, the second product information is stored in a storage area of the storage unit 12. The storage area that stores the second product information may be, for example, a storage area managed by the first company. At this time, a proxy input flag field is generated and a value “1” is stored in the proxy input flag field. The proxy input unit 116 of the first server device 1A invests the first company and the second company with authority to access the second product information.

After the first product information and the second company information are stored in the storage unit 12, the proxy input unit 116 of the first server device 1A transmits a registration completion notification to the first company terminal 2A (step S38). The registration completion notification is a notification that the registration of the first product information has been completed. With this notification, the first company may be requested to check whether the first product information stored in the storage unit 12 is correct.

The proxy input unit 116 of the first server device 1A transmits a temporary registration completion notification to the second company terminal 2B (step S39). The temporary registration completion notification is a notification that the temporary account has been generated. When the second product information is stored in the storage unit 12, a notification is given about this fact. When the second product information is registered as product information of a virtual company or when the second product information is managed by the first company, a notification is given about this fact. The temporary registration completion notification includes a message for a prompt to participate in the first platform. The temporary registration completion notification may be transmitted via the first company terminal 2A.

The second company may participate in the first platform in response to the message for the prompt to participate in the first platform. In that case, the management unit 215 of the second company terminal 2B transmits a participation request to the first server device 1A (step S40). The participation request includes a message indicating that the second company has accepted to participate in the first platform. The participation request may be transmitted via the first company terminal 2A instead of being directly transmitted from the second company terminal 2B to the first server device 1A. That is, the management unit 215 of the second company terminal 2B may transmit the participation request to the first company terminal 2A and the management unit 215 of the first company terminal 2A may transmit the participation request of the second company to the first server device 1A.

The proxy input unit 116 of the first server device 1A that has received the participation request assigns the temporary account of the second company to the second company as a regular account to cause the second company to participate in the first platform (step S41). When a storage area associated with the second company is not allocated, a new storage area is generated and allocated to the second company (step S42). When the second 30) product information is registered in the storage area of the storage unit 12 in association with the first company, the storage area is allocated to the second company by transferring the association from the first company to the second company in step S42. Therefore, the second company can use the second product information registered in association with the first company as it is, thereby saving time and effort required to newly input the second product information.

The proxy input unit 116 of the first server device 1A transmits a registration completion notification to the second company terminal 2B (step S43). The registration completion notification is a notification that the second company has formally been registered on the first platform. This notification may include information on the regular account. With this notification, the second company may be requested to check whether the second product information stored in the storage unit 12 is correct.

As described above, in the present embodiment, the first product information can be acquired from the second platform and stored on the first platform in response to the request from the first company terminal 2A. With such a configuration, the operator can save the time and effort required to input information when registering the product information. By performing at least one of the generation of the temporary account on the first platform for the second company and the registration of the second company information on the first platform in association with the first company, the second company can be prompted to participate in the first platform.

### Second Embodiment

In the first embodiment, the first server device 1A stores the first product information acquired from the second server device 1B. However, the same product may have different amounts of CO₂ emission depending on the locations of the platforms. For example, the ratio of electric power generated by using renewable energy in the electric power supplied to each company varies depending on the country or region where the product is produced. A product produced in a region with a high use ratio of renewable energy has a smaller amount of CO₂ emission in the manufacturing process. Therefore, when the locations of the first platform and the second platform are different, the use of the first product information as it is may cause a decrease in the accuracy of CFP calculation.

Therefore, the proxy input unit 116 of the first server device 1A converts the amount of CO₂ emission acquired from the second server device 1B based on the locations of the first platform and the second platform, and stores the converted amount of CO₂ emission in the storage unit 12 of the first server device 1A. The locations of the first platform and the second platform are regions serving as targets of collection of traceability-related information. For example, in a case of a platform for Japan, the location is Japan even if the server device 1 is located in a country other than Japan.

The proxy input unit 116 of the first server device 1A acquires pieces of information on the locations of the first platform and the second platform. Information stored in the storage unit 12 of each server device 1 can be used as the information on the location of each platform. The proxy input unit 116 of the first server device 1A may acquire information on the use ratio of renewable energy associated with each location. The use ratio of renewable energy is the ratio of the amount of electric power generated by using renewable energy to the amount of electric power generated in each location. A value announced by an electric power company or a government in each country or region can be used for this ratio. The use ratio of renewable energy on the first platform will hereinafter be referred to as “first use ratio”, and the use ratio of renewable energy on the second platform will hereinafter be referred to as “second use ratio”.

The proxy input unit 116 of the first server device 1A obtains a coefficient by calculating, for example, “(1−first use ratio)/(1−second use ratio)”. The amount of CO₂ emission in the first product information is converted by multiplying the amount of CO₂ emission by this coefficient. The method for converting the amount of CO₂ emission is not limited to this. For example, the conversion may be such that the amount of CO₂ emission decreases as the first use ratio is higher than the second use ratio or the amount of CO₂ emission increases as the first use ratio is lower than the second use ratio. This conversion formula is stored in the storage unit 12.

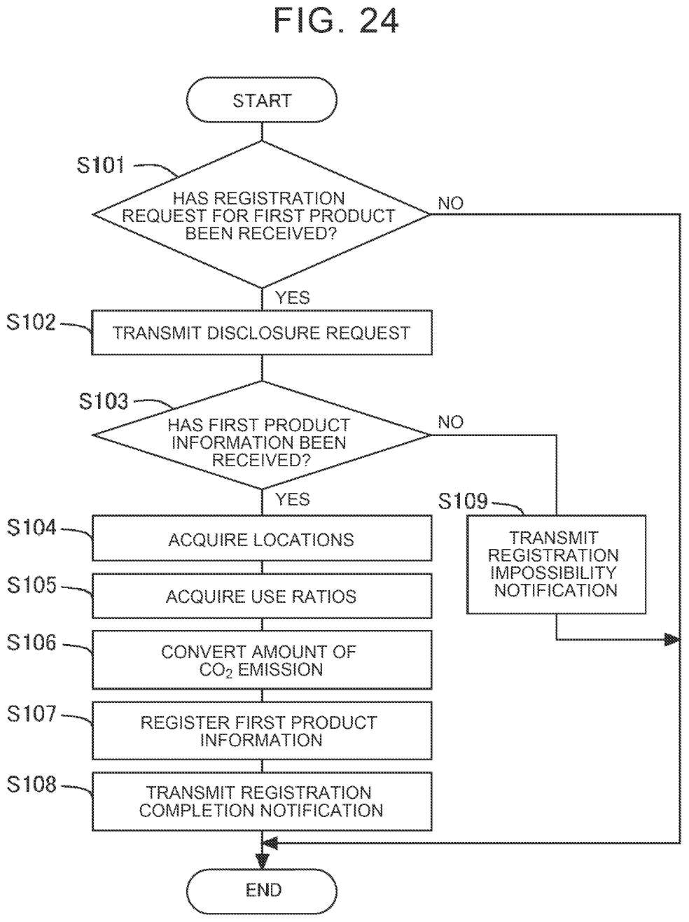

FIG. 24 is a flowchart showing a flow of a registration process for the first product A12 to be performed by the first server device 1A. This routine is executed in the first server device 1A at predetermined time intervals. It is assumed that the first product information has already been stored in the second server device 1B.

In step S101, the proxy input unit 116 determines whether a registration request for the first product A12 has been received. The registration request includes information on the first product A12. The information on the first product A12 includes the identification information of the first product A12 and the information on the second platform (may be the second server device 1B). When the determination result is “Yes” in Step S101, the proxy input unit 116 proceeds to Step S102. When the determination result is “No”, this routine is terminated.

In step S102, the proxy input unit 116 transmits a disclosure request to the second server device 1B. This disclosure request is a request for disclosure of the product information of the first product A12, and includes the identification information of the first product A12. The proxy input unit 116 identifies the destination of the disclosure request based on the information on the second platform that is included in the information received from the first company terminal 2A.

In step S103, the proxy input unit 116 determines whether the first product information has been received from the second server device 1B as a response to the disclosure request. When the second server device 1B refuses to disclose the first product information, the first product information is not transmitted, and a notification is given about the refusal of disclosure. When the determination result is “Yes” in Step S103, the proxy input unit 116 proceeds to Step S104. When the determination result is “No”, the proxy input unit 116 proceeds to Step S109. In step S109, the proxy input unit 116 transmits a registration impossibility notification to the first company terminal 2A. The registration impossibility notification is a notification about the fact that the product information cannot be registered in the first server device 1A. The registration impossibility notification includes the identification information of the first product.

In step S104, the proxy input unit 116 acquires the locations of the first platform and the second platform. The location of the first platform (hereinafter also referred to as “first location”) is stored in the storage unit 12 of the first server device 1A. The location of the second platform (hereinafter also referred to as “second location”) may be acquired from the second platform by sending an inquiry to the second platform, or may be acquired from another server device that stores a relationship between the second platform and the location.

In step S105, the proxy input unit 116 acquires use ratios of renewable energy at the first location and the second location. Since the use ratio of renewable energy associated with each location is disclosed by, for example, a government or an electric power company, the proxy input unit 116 accesses a server device that discloses the use ratio of renewable energy to acquire the use ratio of renewable energy. The use ratio of renewable energy at each location may be stored in the corresponding server device 1. In this case, the proxy input unit 116 may acquire the use ratio of renewable energy at the second location from the second server device 1B.

In step S106, the proxy input unit 116 converts the amount of CO₂ emission in the first product information. The information collecting unit 111 converts the amount of CO₂ emission in the first product information so that the amount of CO₂ emission decreases as the first use ratio is higher than the second use ratio. This conversion is performed by using, for example, the calculation formula stored in the storage unit 12.

In step S107, the proxy input unit 116 replaces the amount of CO₂ emission in the first product information with the amount of CO₂ emission converted in step S106, and stores the first product information in the storage unit 12. In step S108, the proxy input unit 116 transmits a registration completion notification to the first company terminal 2A.

When the second product information is included in the information transmitted from the second server device 1B, the amount of CO₂ emission in the second product information may be converted similarly to the amount of CO₂ emission in the first product information and stored in the storage unit 12 of the first server device 1A.

As described above, in the present embodiment, the amount of CO₂ emission in the first product information and the amount of CO₂ emission in the second product information can automatically be converted based on the locations of the platforms. Therefore, the operators of the first company and the second company can save the time and effort required to convert the information.

### OTHER EMBODIMENTS

The above embodiments are merely illustrative, and the present disclosure may be modified as appropriate without departing from the spirit and scope of the present disclosure. For example, the processes and means described in the present disclosure can be combined as desired as long as no technical contradiction occurs.

In the description of the embodiments, the server device 1 stores the product information in the database, but the product information may be stored by means other than the database.

The description of the embodiments is directed to the form in which the server device 1 completes the product tree by executing the first to fourth phases. However, the roles of the server device 1 may be distributed among a plurality of company terminals 2. For example, the product information may be stored in a distributed database using blockchain infrastructure. In this case, a plurality of company terminals 2 may construct the product information database. In this case, smart contracts may be used to execute the processes in the individual phases. For example, the process in the second phase may be executed in response to writing of permission information to the database with an account of a certain company. The process in the third phase may be executed in response to writing of a linking request to the database with an account of a certain company.

In the description of the embodiments, the phase in which the server device 1 receives product information on an upstream product and the phase in which the server device 1 receives permission information associated with the product information are described separately, but both of them may be received simultaneously. In the description of the embodiments, the phase in which the server device 1 receives product information on a downstream product and the phase in which the server device 1 receives a linking request associated with the product information are described separately, but both of them may be received simultaneously.

In the description of the embodiments, the first platform is provided by the first server device 1A, but the present disclosure is not limited to this. For example, the first server device 1A may be a server that is independent of the first platform and provides information acquired from the second platform to the first platform.

In the above embodiments, the access control on each company is implemented by providing the dedicated storage area and the shared storage area. However, the method for implementing the access control is not limited to such an example. Any method may be used for the access control.

In the above embodiments, the method using the use ratio of renewable energy is exemplified as the method for correcting the amount of CO₂ emission depending on the difference in location. However, the method for correcting the amount of CO₂ emission depending on the difference in location is not limited to this example. In another example, information on transportation, such as a transportation distance and transportation means at each location, may be used together with or instead of the use ratio of renewable energy. In this case, the first server device 1A may convert the amount of CO₂ emission to correct a difference in transportation between the locations in step S106.

In the above embodiments (FIG. 1), the companies in the supply chain are described as companies that produce products. However, the companies in the supply chain need not be the companies that produce products. For example, companies that transport, import, store, or wholesale products may also be included in the companies constituting the supply chain. In one example, some of the companies may be companies that do not execute manufacturing processes, such as trading companies, sales agents, or import agents, and may receive products from companies positioned one level higher (upstream companies) and deliver the products to companies positioned one level lower (downstream companies).

In the above embodiments, the supply chain of automotive products is assumed, the OEM is described as the most downstream company, and the companies that supply components, materials, assemblies, etc. are described as the suppliers. However, the companies belonging to the supply chain are not necessarily limited to these companies. The company in each stage may be determined as appropriate depending on the product etc. The manufacturing activities performed by the companies until the final product is obtained may be determined as appropriate depending on embodiments, and may include all activities that can be performed until the final product is obtained, such as excavation, machining, assembling, transportation, and storage.

In the above embodiments, the server device 1 executes the information processing in the first to fourth phases in addition to the information processing related to the information disclosure request to another platform (FIGS. 23 and 24). However, the configuration of the server device 1 is not limited to such an example. In another example, the information processing in at least one of the first to fourth phases may be omitted in the server device 1. The server device 1 may execute any other information processing.

The above embodiments show the example of calculation of the amount of CO₂ emission (CFP value). The CFP value may be calculated by the following calculation formula.

Tier N−1 CFP value=Tier N−1 in-house measured CFP value+Σₖ (CFP value of company k (Tier N)×use amount uₖ in Tier N−1)

In this formula, the “Tier N−1 CFP value” indicates a result of integrating the CFP value of the upstream company (company k (Tier N)) and the CFP value of the company of interest. The in-house measured CFP value indicates a CFP value included in the product information of each company. When Tier N is the most upstream company, a “Tier N CFP value” is a CFP value included in the product information of this company. In other cases, the “Tier N CFP value” is a result of integrating a CFP value of an upstream company (Tier N+1) and the CFP value included in the product information of the company of interest. When Tier N is set as the most upstream company (terminal end company) and the calculation is repeated until N=1, the CFP value of a Tier 0 product (=final product) can be obtained.

In the above embodiments, the server device 1 may calculate the recycling rate and the due diligence (score) together with or instead of the calculation of the amount of CO₂ emission (CFP value). The recycling rate may be calculated by the following calculation formula.

“(Recycling rate of target substance in Tier N−1 product)={(total use amount in Tier N−1) ×(recycling rate in Tier N−1)+Σₖ (total use amount in company k (Tier N)×recycling rate in company k (Tier N)×use amount uₖ in Tier N−1)}÷{total use amount in Tier N−1+Σₖ (total use amount in company k (Tier N)×use amount uₖ in Tier N−1)}={recycled material use amount in Tier N−1+Σₖ (recycled material use amount in company k (Tier N)×use amount Σₖ in Tier N−1)}÷{total use amount in Tier N−1+Σₖ (total use amount in company k (Tier N)×use amount uₖin Tier N−1)}”

The recycled material use amount indicates an amount of the recycled material used in the target substance. Similarly to the CFP value, the recycling rate of the target substance in the final product can be calculated by sequential calculation from the most upstream company (terminal end company). The due diligence score (DD score) can be integrated by calculation similar to those for the CFP value and the recycling rate. In one example, the DD score (integrated result) in the final product can be obtained by replacing the CFP value with the DD score and performing sequential calculation from the most upstream company (terminal end company).

In the above embodiments, the traceability-related information of each company (Tier N−1) other than the most upstream company need not be stored in the shared storage area between the company and its downstream company, and the integration result of each company (Tier N−1 CFP value and recycling rate of target substance in Tier N−1 product) may be stored in the shared storage area between the company and its downstream company (Tier N−2). Thus, it is possible to obtain the traceability-related information (integration result) of the final product without disclosing the traceability-related information of each company.

In the above embodiments, it is assumed that each company places an order for a certain material with one company. In the above embodiments, however, the order format of each company is not limited to such an example. At least a part of the companies belonging to the supply chain may place an order for the same product with a plurality of upstream companies and use the obtained upstream products selectively for the in-house product. In the example of FIG. 13, a product A11_1, a product A11_2, or a product A11_3 in Tier 2 may be used selectively for the product A1 in Tier 1. In this case, the server device 1 may hold the linking relationship for each pattern for use. In the above example, the server device 1 may hold pieces of linking information for the product A1 in Tier 1, such as a pattern 1 “product A11_1 in Tier 2 . . . ,” a pattern 2 “product A11_2, . . . ,” and a pattern 3 “product A11_3 . . . . ” In response to this, the server device 1 may execute the calculation (integration) of the traceability-related information for each pattern. In one example, the server device 1 may output the calculation result for each pattern. In another example, the server device 1 may calculate, based on the calculation result, statistics such as a maximum value, a minimum value, an average value, a variance, a standard deviation, and a median of the calculation result, and output the calculated statistics.

In the above embodiments, the traceability-related information (in particular, CFP value) may be composed of primary data or may be composed of secondary data (inventory data). The primary data is a measured value, and the secondary data is a reference value to be used when the measured value is not obtained. In this case, the calculation (integration) of the traceability-related information may include calculating the primary data ratio of the traceability-related information obtained for the final product. The primary data ratio may be calculated by simple ratio calculation, or by weighted calculation involving replacing the CFP value with the primary data ratio of each company in the above CFP value calculation formula and performing sequential calculation from the most upstream company.

The process described as being executed by a single device may be executed by a plurality of devices in cooperation. Alternatively, the process described as being executed by different devices may be executed by a single device. In a computer system, the hardware configuration (server configuration) that implements functions can be changed flexibly.

The present disclosure may be embodied such that a computer program that implements the functions described in the above embodiments is supplied to a computer and is read and executed by one or more processors of the computer. The computer program may be provided to the computer by being stored in a non-transitory computer-readable storage medium connectable to a system bus of the computer, or may be provided to the computer via a network. Examples of the non-transitory computer-readable storage medium include any types of disk or disc such as magnetic disks (e.g., a floppy (registered trademark) disk and a hard disk drive (HDD)) and optical discs (e.g., a compact disc ROM (CD-ROM), a digital versatile disc (DVD), and a Blu-ray disc), a read only memory (ROM), a random access memory (RAM), an EPROM, an electrically erasable programmable ROM (EEPROM), a magnetic card, a flash memory, an optical card, and any types of medium suitable to store electronic instructions.

What is claimed is:

1. An information processing device comprising one or more processors configured to execute:
receiving identification information of a first product and information on a second platform from a terminal of a first company, the first company having not registered information on the first product on a first platform and having already registered the information on the first product on the second platform different from the first platform;
transmitting a disclosure request for the information on the first product to the second platform, the disclosure request including the identification information of the first product;
receiving the information on the first product and information on a second company from the second platform in response to the disclosure request, the second company being a company of a second product positioned upstream of the first product;
registering the information on the first product on the first platform in association with the first company; and
performing, for the second company, at least one of
generating a temporary account on the first platform, and
registering the information on the second company on the first platform in association with the first company.

2. The information processing device according to claim 1, wherein the information on the first product includes traceability-related information of the first product.

3. The information processing device according to claim 2, wherein the traceability-related information includes information on an amount of greenhouse gas emission.

4. The information processing device according to claim 3, wherein:
the one or more processors are configured to execute
acquiring information on location of the first platform and information on location of the second platform, and
converting the information on the amount of greenhouse gas emission based on a relationship between the location of the first platform and the location of the second platform; and
the registering the information on the first product includes registering the converted information on the amount of greenhouse gas emission in association with the first company.

5. The information processing device according to claim 1, wherein the one or more processors are configured to execute at least one of the transmitting and the receiving via a predetermined connector.

6. The information processing device according to claim 1, wherein:
the information on the second company includes information on the second product; and
the registering the information on the second company includes registering the information on the second product in association with the first company as a proxy applicant of the information on the second product.

7. The information processing device according to claim 1, wherein the information on the first product that is received from the second platform by the one or more processors includes information indicating designation of a disclosure range by the terminal of the first company.

8. The information processing device according to claim 1, wherein the one or more processors are configured to, when the one or more processors have executed the generating the temporary account on the first platform, assign the temporary account generated on the first platform to the second company as a regular account in response to a message that is received from the terminal of the first company or a terminal of the second company and that indicates that the second company has accepted to participate in the first platform.

9. The information processing device according to claim 8, wherein:
the information on the second company includes information on the second product;
a storage area that stores the information on the second product is associated with the first company until the regular account is assigned to the second company; and
association of the storage area is transferred from the first company to the second company after the regular account is assigned to the second company.

10. The information processing device according to claim 1, wherein the first product and the second product are products related to a battery.

11. An information processing method comprising executing, by a computer:
receiving identification information of a first product and information on a second platform from a terminal of a first company, the first company having not registered information on the first product on a first platform and having already registered the information on the first product on the second platform different from the first platform;
transmitting a disclosure request for the information on the first product to the second platform, the disclosure request including the identification information of the first product;
receiving the information on the first product and information on a second company from the second platform in response to the disclosure request, the second company being a company of a second product positioned upstream of the first product;
registering the information on the first product on the first platform in association with the first company; and
performing, for the second company, at least one of
generating a temporary account on the first platform, and
registering the information on the second company on the first platform in association with the first company.

12. The information processing method according to claim 11, wherein the information on the first product includes traceability-related information of the first product.

13. The information processing method according to claim 12, wherein the traceability-related information includes information on an amount of greenhouse gas emission.

14. The information processing method according to claim 13, further comprising executing, by the computer:
acquiring information on location of the first platform and information on location of the second platform; and
converting the information on the amount of greenhouse gas emission based on a relationship between the location of the first platform and the location of the second platform,
wherein the registering the information on the first product includes registering the converted information on the amount of greenhouse gas emission in association with the first company.

15. The information processing method according to claim 11, further comprising executing, by the computer, at least one of the transmitting and the receiving via a predetermined connector.

16. The information processing method according to claim 11, wherein:
the information on the second company includes information on the second product; and
the registering the information on the second company includes registering the information on the second product in association with the first company as a proxy applicant of the information on the second product.

17. The information processing method according to claim 11, wherein the information on the first product that is received from the second platform by the computer includes information indicating designation of a disclosure range by the terminal of the first company.

18. The information processing method according to claim 11, further comprising executing, by the computer, when the computer has executed the generating the temporary account on the first platform, assigning the temporary account generated on the first platform to the second company as a regular account in response to a message that is received from the terminal of the first company or a terminal of the second company and that indicates that the second company has accepted to participate in the first platform.

19. The information processing method according to claim 18, wherein:
the information on the second company includes information on the second product;
a storage area that stores the information on the second product is associated with the first company until the regular account is assigned to the second company; and
association of the storage area is transferred from the first company to the second company after the regular account is assigned to the second company.

20. The information processing method according to claim 11, wherein the first product and the second product are products related to a battery.
